(19) United States
(12) Patent Application Publication
(10) Pub. No.: US 2005/0071136 A1
(43) Pub. Date: Mar. 31, 2005

(54) Knowledge management system with interactive rule changes for computer-aided design modeling

(76) Inventors: David W. Vredenburgh, Wenham, MA (US); Gregory J. Smith, Lyndhurst, OH (US); Robert J. Mattern, Akron, OH (US)

Correspondence Address: BROMBERG & SUNSTEIN LLP, 125 SUMMER STREET, BOSTON, MA, 02110-1618, US

(21) Appl. No.: 10/818,475

(22) Filed: Apr. 5, 2004

Related U.S. Application Data
(63) Continuation-in-part of application No. 10/675,809, filed on Sep. 30, 2003.

(51) Int. Cl. G06F 17/00; G06N 5/02; G06F 17/50

(52) U.S. Cl. 703/1; 706/47

(57) ABSTRACT

Interactive rule changes made during a run time are applied to a computer-aided design model. An in-memory model is produced from a set of rules, and instructions are generated for a computer-aided design system based on the in-memory model. The in-memory model is updated based on interactive rule changes. The set of rules may be stored in a database, and the set of rules in the database may be selectively updated based on the interactive rule changes. Class files may be generated based on the set of rules, and the class files may be selectively updated based on the interactive rules changes.

### CROSS-REFERENCE TO RELATED APPLICATION(S)

The present application is a continuation-in-part of U.S. patent application Ser. No. 10/675,809 entitled KNOWLEDGE MANAGEMENT SYSTEM FOR COMPUTER-AIDED DESIGN MODELING, which was filed on Sep. 30, 2003 in the names of David W. Vredenburgh, Gregory J. Smith, and Robert J. Mattern, and is hereby incorporated herein by reference in its entirety.

### FIELD OF THE INVENTION

The present invention relates generally to computer-aided design, and, more particularly, to a knowledge management system for computer-aided design modeling.

### BACKGROUND OF THE INVENTION

Computer-aided design (CAD) systems can be used to produce and manipulate geometric models. CAD systems often include very sophisticated algorithms for producing complex geometric models, manipulating those models, and analyzing the components of those models. For example, a CAD system may be used to model a complex structure having a curved surface, view the structure at various angles, and calculate the surface area of the curved surface and the volume of the structure as a whole. It might be useful to know the surface area of the curved surface, for example, to determine how much paint would be needed to cover the surface. It might be useful to know the volume of the structure, for example, to determine how much material would be needed to produce the structure.

While CAD systems can be very powerful modeling tools, they are generally limited to geometric modeling. Thus, CAD systems generally require the user to apply product design rules and practices necessary to produce the model. For example, if the user is required by an employer to use certain practices (such as, for example, always using a certain size bolt to connect two components), then the user must apply those practices to the model. The user is typically also required to make successive changes to a model when changing a component of the model. For example, each time the user changes an attribute of a component (such as, for example, the outside diameter of a component), the user may have to change attributes of one or more other components that connect or otherwise interact with that component, and the effects of these changes may cascade through many components of the model. The user is typically also required to handle non-geometric attributes of the model (such as, for example, component pricing and manufacturing processes). As a result of these limitations, CAD systems can be difficult to use, particularly for casual CAD users (such as engineers, architects, or managerial staff) who may not be proficient with the CAD system but often need to make modifications to drawings or models on an as-needed basis.

Knowledge-based engineering (KBE) attempts to combine some level of knowledge management with design automation. Knowledge management typically includes such things as best practices, lessons learned (e.g., from earlier models), common practices (e.g., industry standards, company policies), product design rules, and quality metrics. Knowledge management might be applied to design automation, for example, to reduce the number of parts a company needs to order (e.g., by reusing parts from one model in another model), reduce design time, reduce product cost, and produce higher quality and reliability. KBE functionality is typically implemented within a CAD system or as an add-on to a CAD system (e.g., as a plug-in) so as to provide the CAD system with additional knowledge management capabilities.

CAD systems are often used in conjunction with computer-aided engineering (CAE) analysis tools for performing advanced model analysis. CAD systems are also often used in conjunction with product document management (PDM) tools for generating and maintaining product documentation. These CAE and PDM tools can be implemented as stand-alone applications or as add-ons to a CAD system. The KBE functionality may interact with the CAE and PDM tools to gather or provide information.

### SUMMARY OF THE INVENTION

In embodiments of the present invention, interactive rule changes made during a run time are applied to a computer-aided design model. An in-memory model is produced from a set of rules, and instructions are generated for a computer-aided design system based on the in-memory model. The in-memory model is updated based on interactive rule changes. The set of rules may be stored in a database, and the set of rules in the database may be selectively updated based on the interactive rule changes. Class files may be generated based on the set of rules, and the class files may be selectively updated based on the interactive rules changes.

Thus, in accordance with one embodiment of the present invention there is provided a computer-aided modeling system including a knowledge management system for managing a set of modeling rules and a computer-aided design system controlled by the knowledge management system. The knowledge management system generates instructions for the computer-aided design system based on an in-memory model derived from a set of rules and updates the in-memory model and the instructions based on interactive rule changes made by a user. Interactive rule changes may include addition of a new subpart for a model, addition of a new part for a model, and/or addition of a new property for a part for the model.

The set of rules are typically captured at a capture time and the interactive rule changes are typically made during a run time during which computer-aided design models are generated. Thus, the knowledge management system typically includes a capture facility for capturing the set of rules during a capture time and a run-time facility for generating the in-memory model and the instructions during a run time. The run-time facility updates the in-memory model and the instructions based on interactive rule changes made by the user during the run time.

In addition to updating the in-memory model and instructions based on interactive rule changes, the knowledge management system may store the set of rules in a database and selectively update the set of rules in the database based on the interactive rule changes. In certain embodiments of the present invention, the knowledge management system produces class files from the set of rules and produces the in-memory model based on the class files, and the knowledge management system may selectively update the class files based on the interactive rule changes and generates an updated in-memory model and updated instructions based on the updated class files. The knowledge management system may interpret the updated class files to produce the updated in-memory model or may compile the updated class files to produce the updated in-memory model.

In accordance with another embodiment of the present invention there is provided a method for computer-aided design modeling involving generating an in-memory model based on a set of rules, generating instructions for a computer-aided design system based on the in-memory model, receiving an interactive rule change, updating the in-memory model based on the interactive rule change, and generating updated instructions for the computer-aided design system based on the updated in-memory model. The set of rules are typically captured at a capture time and the interactive rule changes are typically made during a run time during which computer-aided design models are generated. Interactive rule changes may include addition of a new subpart for a model, addition of a new part for a model, and/or addition of a new property for a part for the model.

In addition to updating the in-memory model and instructions based on interactive rule changes, the knowledge management system may store the set of rules in a database and selectively update the set of rules in the database based on the interactive rule changes. In certain embodiments of the present invention, the knowledge management system produces class files from the set of rules and produces the in-memory model based on the class files, and the knowledge management system may selectively update the class files based on the interactive rule changes and generates an updated in-memory model and updated instructions based on the updated class files. The knowledge management system may interpret the updated class files to produce the updated in-memory model or may compile the updated class files to produce the updated in-memory model.

In accordance with another embodiment of the present invention there is provided apparatus for computer-aided design modeling including a capture facility for capturing a set of rules and storing the set of rules in a database during a capture time and a run-time facility for producing an in-memory model in a working memory based on the set of rules and generating instructions for a computer-aided design system based on the in-memory model during a run time. The run-time facility updates the in-memory model based on interactive rule changes received from a user and generates updated instructions for the computer-aided design system based on the updated in-memory model. Interactive rule changes may include addition of a new subpart for a model, addition of a new part for a model, and/or addition of a new property for a part for the model.

In addition to updating the in-memory model and instructions based on interactive rule changes, the knowledge management system may store the set of rules in a database and selectively update the set of rules in the database based on the interactive rule changes. In certain embodiments of the present invention, the knowledge management system produces class files from the set of rules and produces the in-memory model based on the class files, and the knowledge management system may selectively update the class files based on the interactive rule changes and generates an updated in-memory model and updated instructions based on the updated class files. The knowledge management system may interpret the updated class files to produce the updated in-memory model or may compile the updated class files to produce the updated in-memory model.

In accordance with another embodiment of the present invention there is provided apparatus including a computer readable medium having embodied therein a computer program for computer-aided design modeling. The computer program includes means for capturing a set of rules for computer-aided design modeling, means for generating an in-memory model in a working memory based on the set of rules, means for generating instructions for a computer-aided design system based on the in-memory model, means for updating the in-memory model based on interactive rule changes received from a user during a run time, and means for generating updated instructions for the computer-aided design system based on the updated in-memory model. The set of rules are typically captured at a capture time and the interactive rule changes are typically made during a run time during which computer-aided design models are generated. Interactive rule changes may include addition of a new subpart for a model, addition of a new part for a model, and/or addition of a new property for a part for the model.

The set of rules are typically stored in a database, and therefore the apparatus may include means for storing the set of rules in a database and means for selectively updating the set of rules in the database based on the interactive rule changes. The means for generating an in-memory model may include means for generating class files from the set of rules and means for generating the in-memory model from the class files, in which case the means for updating the in-memory model based on interactive rule changes may include means for updating the class files based on the interactive rule changes and means for generating an updated in-memory model based on the updated class files. The means for generating an updated in-memory model based on the updated class files may include means for interpreting the updated class files to produce the updated in-memory model or means for compiling the updated class files to produce the updated in-memory model.

In accordance with another embodiment of the present invention there is provided apparatus for computer-aided design modeling including means for generating a computer-aided design model based on a set of rules and means for interactively updating the computer-aided design model based on interactive rule changes.

### BRIEF DESCRIPTION OF THE DRAWINGS

In the accompanying drawings:

FIG. 1 is a block diagram showing an exemplary modeling system in accordance with an embodiment of the present invention;

FIG. 2 is a block diagram showing the relevant components of the knowledge management system in accordance with an embodiment of the present invention;

FIG. 3A is a block diagram showing relevant components of the CAD system in accordance with an embodiment of the present invention;

FIG. 3B is a block diagram showing the relevant components of a CAD program in accordance with an embodiment of the present invention;

FIG. 4 is a block diagram showing an exemplary computer-aided modeling system in accordance with an embodiment of the present invention;

FIG. 5 shows an exemplary user interface screenshot for importing information from the CAD system relating to a mounting assembly, such as might be generated by the knowledge management application in accordance with an embodiment of the present invention;

FIG. 6 shows an exemplary user interface screenshot for defining a new geometric specification relating to the Mounting part family, such as might be generated by the knowledge management application in accordance with an embodiment of the present invention;

FIG. 7 shows an exemplary user interface screenshot displaying information upon entry of the name of a new CAD part file, such as might be generated by the knowledge management application in accordance with an embodiment of the present invention;

FIG. 8 shows an exemplary user interface screenshot for defining a geometry feature, such as might be generated by the knowledge management application in accordance with an embodiment of the present invention;

FIG. 9 shows an exemplary user interface screenshot showing geometry features (properties) defined for the CAD part file, such as might be generated by the knowledge management application in accordance with an embodiment of the present invention;

FIG. 10 shows an exemplary user interface screenshot for defining a mating, such as might be generated by the knowledge management application in accordance with an embodiment of the present invention;

FIG. 11 shows an exemplary user interface screenshot showing mating definitions, such as might be generated by the knowledge management application in accordance with an embodiment of the present invention;

FIG. 12 shows an exemplary user interface screenshot showing a rule for determining a fan area for the fan, such as might be generated by the knowledge management application in accordance with an embodiment of the present invention;

FIG. 13 shows an exemplary user interface screenshot including an embedded graphical representation of a model generated by the CAD system, such as might be generated by the knowledge management application in accordance with an embodiment of the present invention;

FIG. 14 shows a first exemplary user interface screenshot including a sub-window generated by the CAD system, such as might be generated by the knowledge management application in accordance with an embodiment of the present invention;

FIG. 15 shows a second exemplary user interface screenshot including a sub-window generated by the CAD system, such as might be generated by the knowledge management application in accordance with an embodiment of the present invention;

FIG. 16 shows a third exemplary user interface screenshot including a full view window generated by the CAD system, such as might be generated by the knowledge management application in accordance with an embodiment of the present invention;

FIG. 17 shows an exemplary user interface screenshot including a window generated by a two-dimensional CAD system, such as might be generated by the knowledge management application in accordance with an embodiment of the present invention;

FIG. 18 shows an exemplary user interface screenshot including an analysis window, such as might be generated by the knowledge management application in accordance with an embodiment of the present invention;

FIG. 19 shows the relationship between the user (engineer), knowledge management application, knowledge database, and the integrated systems controlled by the knowledge management application in accordance with an embodiment of the present invention; and

FIG. 20 shows the relationship between the knowledge management application and the integrated systems in greater detail;

FIG. 21 is a logic flow diagram showing exemplary logic for class-based rules in accordance with an embodiment of the present invention;

FIG. 22 is a logic flow diagram showing exemplary logic for the knowledge management application in accordance with an embodiment of the present invention;

FIG. 23 is a conceptual logic flow diagram describing computer-aided design modeling with interactive rule changes in accordance with an embodiment of the present invention;

FIG. 24 is a logic flow diagram showing exemplary logic for computer-aided design modeling with interactive rule changes in accordance with an embodiment of the present invention;

FIG. 25 is a conceptual block diagram showing a computer-aided modeling system with interactive rule changes in accordance with an embodiment of the present invention;

FIG. 26 is a conceptual block diagram showing the relationships between rules, classes, and instances for computer-aided design modeling with interactive rule changes in accordance with an embodiment of the present invention;

FIG. 27 is an exemplary screenshot showing a menu for beginning an interactive rule change in accordance with an embodiment of the present invention;

FIG. 28 is an exemplary screenshot showing a dialog box for interactively adding a subpart in accordance with an embodiment of the present invention;

FIG. 29 is an exemplary screenshot showing a pull-down menu for specifying the part family for the new subpart in accordance with an embodiment of the present invention;

FIG. 30 is an exemplary screenshot showing a dialog box for specifying a new part family in accordance with an embodiment of the present invention;

FIG. 31 is an exemplary screenshot showing a dialog box for adding a new formula-driven subpart in accordance with an embodiment of the present invention;

FIG. 32 is an exemplary screenshot showing the results of adding the Bumpers subpart from FIG. 31 in accordance with an embodiment of the present invention;

FIG. 33 is an exemplary screenshot showing a dialog box for adding a new property to an existing part in accordance with an embodiment of the present invention;

FIG. 34 is an exemplary screenshot showing a dialog box for adding a new part in accordance with an embodiment of the present invention;

FIG. 35 is an exemplary screenshot showing a dialog box for selecting an existing CAD system part file in accordance with an embodiment of the present invention;

FIG. 36 is an exemplary screenshot showing a dialog box for adding a new property for a part that is associated with a CAD system file in accordance with an embodiment of the present invention;

FIG. 37 is an exemplary screenshot showing a dialog box for selecting the CAD system features to drive with a new property in accordance with an embodiment of the present invention;

FIG. 38 is an exemplary screenshot showing the results of a newly added property in accordance with an embodiment of the present invention;

FIG. 39 is an exemplary screenshot showing a dialog box for adding mating/orientation rules in accordance with an embodiment of the present invention;

FIG. 40 is an exemplary screenshot showing a dialog box for entering CAD system mating commands in accordance with an embodiment of the present invention;

FIG. 41 is an exemplary screenshot showing a dialog box showing a new mating in accordance with an embodiment of the present invention; and

FIG. 42 is an exemplary screenshot showing a computer-aided design model including a new mating in accordance with an embodiment of the present invention.

### DETAILED DESCRIPTION OF A PREFERRED EMBODIMENT

In embodiments of the present invention, a knowledge management system captures, stores, manages, and applies rules for modeling geometric objects and related non-geometric attributes, and includes integrated support for one or more third party product document management (PDM) systems for storing and managing knowledge management system documents. An exemplary knowledge management system is described below and in the related U.S. patent application Ser. No. 10/675,809 incorporated by reference above. The knowledge management system may be referred to as “Rulestream” or “Navion.”

The knowledge management system preferably supports rules relating to geometric attributes that can be represented and manipulated by a CAD system as well as rules relating to various other attributes that generally cannot be represented and manipulated by the CAD system, such as certain “negative” geometric attributes (e.g., a specification for producing a hole in a component or for removing material from a component so as to form a feature of that component), certain geometry-based attributes that are not modeled as physical features of a structure or assembly, and non-geometric attributes (e.g., pricing, processes, component relationships, component classes, user intentions, and abstractions). The rules are typically stored in a central database so that the rules can be manipulated independently of any modeling. The rules can be derived from various sources, including general engineering principles, user-provided information, and information obtained from a PDM system. The knowledge management system can track rule changes over time, and can apply a particular version of the rules to a model. The knowledge management system defines the components and parameters for a particular model based on the rules being applied. The knowledge management system can incorporate predefined components (such as components created in a CAD system) or dynamically defined components into the model.

The knowledge management system is generally independent of the CAD system, although the knowledge management system can interface with a CAD system for, among other things, importing/integrating component specifications from the CAD system for use in modeling, instructing the CAD system to produce a geometric model incorporating the components and parameters defined by the knowledge management system, and obtaining geometric information relating to a model (e.g., sizes, surface areas, volumes) for use by the knowledge management system (e.g., for computing the cost of a component based on its volume according to pricing rules provided by a user). A geometric model produced by the CAD system can be viewed and manipulated as usual using the CAD system, although it is preferable for any and all changes to the model to be coordinated through the knowledge management system so that the appropriate rules can be applied to the changes.

In certain embodiments of the present invention, the knowledge management system interfaces with the CAD system through an application program interface (API) of the CAD system. Specifically, the CAD system includes an API through which certain functions of the CAD system can be performed. The CAD system API is typically used for such things as macros (i.e., programs that perform a series of function steps for the user) and add-ons (i.e., programs that add functionality to the CAD system). In embodiments of the present invention, however, the knowledge management system uses the API to control the CAD system such that the CAD system runs only when activated by the knowledge management system. The knowledge management system typically activates the CAD system for such things as displaying a model to the user and obtaining geometric information relating to model components.

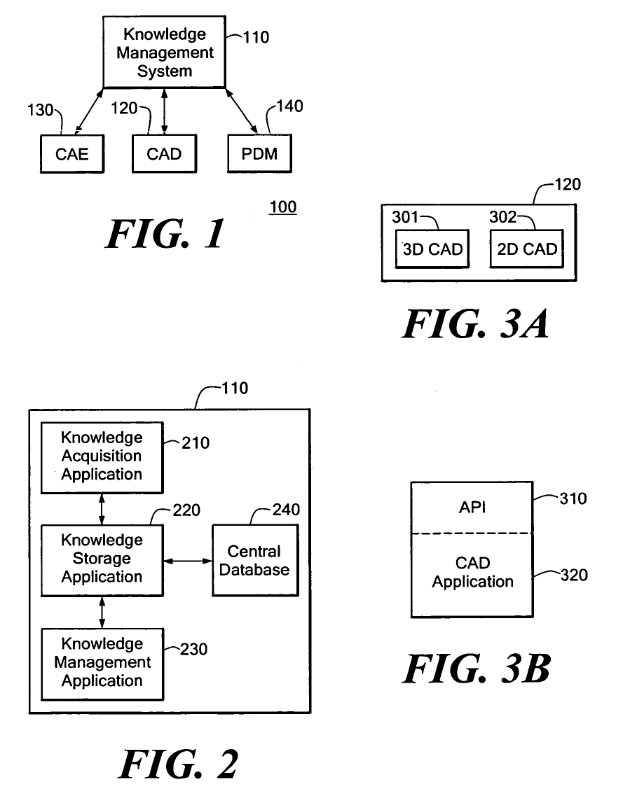

FIG. 1 is a block diagram showing an exemplary modeling system 100 in accordance with an embodiment of the present invention. Among other things, the modeling system 100 includes a knowledge management system 110 in communication with a CAD system 120. The knowledge management system 110 controls the CAD system 120, specifically by generating instructions for modeling a geometric structure based on a set of modeling rules and communicating the instructions to the computer-aided design system 120 for generating a model of the geometric structure. The knowledge management system 110 can also interface with a CAE application 130 for analysis and with a PDM application 140 for product document management.

FIG. 2 is a block diagram showing the relevant components of the knowledge management system 110 in accordance with an embodiment of the present invention. Among other things, the knowledge management system 110 includes a knowledge acquisition application 210 for capturing and generating rules, a knowledge storage application 220 for storing rules and models in a central database 240, and a knowledge management application 230 for generating models based on the rules. The knowledge management application may be referred to as “nAct” or “RuleStream Engineer,” the knowledge acquisition application may be referred to as “nAct Expert” or “RuleStream Architect,” and the knowledge storage application may be referred to as “nPlatform” or “RuleStream Platform.” Among other things, the knowledge acquisition application 210 generates rule programs based on information obtained from a user and communicates the rule programs to the knowledge storage application 220 for storage in the central database 240. The knowledge management application 230 obtains rule programs from the knowledge storage application 220 and applies the rule programs for building a model. The knowledge management application 230 may communicate model information to the knowledge storage application 220 for storage in the central database 240.

More specifically, the knowledge acquisition application 210 captures modeling rules and generates rule programs for storage by the knowledge storage application 220. The knowledge acquisition application 210 interacts with a user through a user interface through which the user enters information regarding components, design processes, engineering and manufacturing rules, and customer and marketing requirements. The knowledge acquisition application 210 generates rule programs from the user information, and sends the rule programs to the knowledge storage application 220 for storage. The knowledge acquisition application 210 allows rules to be modified quickly and easily.

The knowledge storage application 220 stores modeling information in a relational database, including, among other things, rule programs generated by the knowledge acquisition application 210 and models generated by the knowledge management application 230. The knowledge storage application 220 also tracks revision histories, design status, and user group security. Multiple revisions of a rule can be stored so that a particular version of a rule can be applied to a model while another version of the rule is being created or modified. A design can be modeled using an earlier version of a rule if desired.

The knowledge management application 230 applies rules to create detailed computer models. The knowledge management application 230 can model two-dimensional schematics or three-dimensional geometries. The knowledge management application 230 can also model a bill of materials for the components of an assembly. The knowledge management application 230 can automatically update a previously completed model under revised or new rules. In this way, models can be generated by manipulating the rules through the knowledge management system rather than manipulating the model itself through the computer-aided design system.

FIG. 3A is a block diagram showing relevant components of the CAD system 120 in accordance with an embodiment of the present invention. Among other things, the CAD system 120 includes a 3D CAD program 301, such as such as SOLIDWORKS™ from SolidWorks Corporation, 300 Baker Avenue, Concord, Mass. 01742, and may also include a 2D CAD program 302, such as VISIO™ from Microsoft Corporation. Each of the CAD programs has its own API through which it interacts with the knowledge management application. FIG. 3B is a block diagram showing the relevant components of a CAD program, such as the 3D CAD program 301 or the 2D CAD program 302, in accordance with an embodiment of the present invention. Among other things, the CAD program includes a CAD application 320 having an API 310 through which certain functions of the CAD application 320 can be controlled. The interactions between the knowledge management application and different CAD systems depend to a large degree on the CAD system API. The SOLIDWORKS™ three-dimensional CAD program has an internal macro/recording language and also supports an application programming interface language that is accessible through an OLE (Object Linking and Embedding) interface with support for VISUAL BASIC™ and VISUAL C++™. In an exemplary embodiment of the present invention, the knowledge management application is substantially reactive to the VISIO™ two-dimensional CAD system, while the knowledge management application actively controls the SOLIDWORKS™ three-dimensional CAD system. Thus, support for each particular CAD system generally requires some level of integration by the knowledge management application to work with the specific functions and API of the CAD program.

In certain embodiments of the present invention, the various functions of the knowledge management system 110 are divided among different devices that communicate over a communication network, such as the public Internet or public or private intranets. In an exemplary embodiment of the present invention, knowledge storage functions reside in one or more storage servers that incorporate the knowledge storage application 220 and central database 240, while knowledge acquisition and management functions reside in user workstations (such as personal computers) or terminals that incorporate the knowledge acquisition application 210, the knowledge management application 230, and the CAD system 120. The user workstations or terminals typically include a user interface for interacting with a user and a network interface for communicating with the storage server over a communication network.

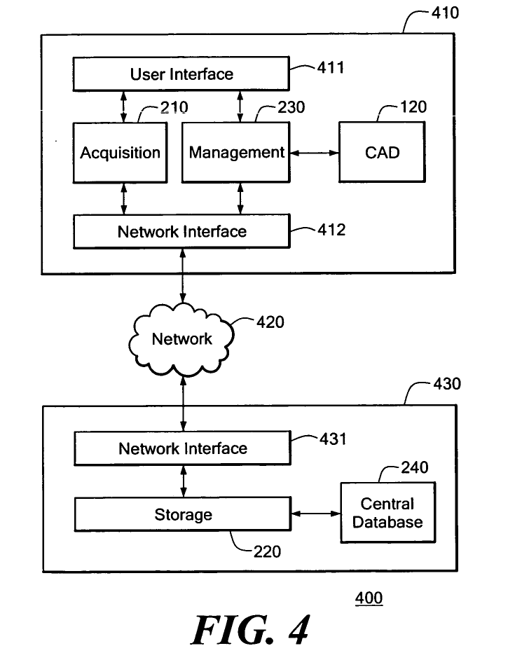

FIG. 4 is a block diagram showing an exemplary computer-aided modeling system in accordance with an embodiment of the present invention. Among other things, the system 400 includes one or more user workstations 410 in communication with one or more storage servers 430 over a communication network 420. The workstation 410 incorporates the knowledge acquisition application 210, the knowledge management application 230, and the CAD system 120, and also includes a user interface for interacting with the user and a network interface for communicating over the communication network 420 with the storage server(s) 430. The user interface 411 is typically a graphical user interface that provides for both displaying information to the user and receiving inputs from the user. The storage server 430 incorporates the knowledge storage application 220 and the central database 240, and also includes a network interface 431 for communicating over the communication network 420 with the user workstation(s) 410.

Within the user workstation 410, the knowledge acquisition application 210 and the knowledge management application 230 interact with the user through the user interface 411, and also interact with the knowledge storage application 220 in the storage server 430 through the network interface 412 using a client-server paradigm. The knowledge management application 230 also controls the CAD system 120 through an API of the CAD system 120. The user workstation 410 is typically a general-purpose computer, and the knowledge acquisition application 210, the knowledge management application 230, and the CAD system 120 are typically software programs that run on the general-purpose computer.

Within the storage server 430, the knowledge storage application 220 interacts with the central database 240 through a database interface (not shown), and interacts with the knowledge acquisition application 210 and the knowledge management application 230 in the user workstation 410 through the network interface 431. The storage server 430 is typically a general-purpose computer, and the knowledge storage application 220 is typically a software program that runs on the general-purpose computer. The central database 240 is typically a relational database.

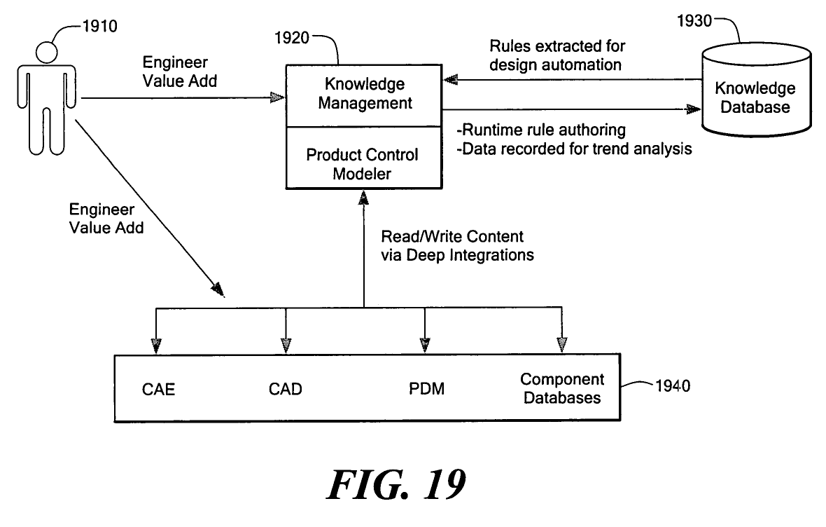

FIG. 19 shows the relationship between the user (engineer) 1910, knowledge management application 1920, knowledge database 1930, and the integrated systems 1940 controlled by the knowledge management application 1920, including CAD system(s) and possibly also a CAE application, a PDM application, and a component databases. The knowledge management application 1920 extracts rules for design automation from the knowledge database 1930. The knowledge management application 1920 may also receive specifications, rules, and other information relating to modeling. A product control modeler element of the knowledge management application 1920 interacts with the integrated applications as necessary for modeling, analysis, product document management, and component selection. Information generated by the knowledge management application 1920, such as runtime rule authoring and trend analysis, may be stored in the knowledge database 1930.

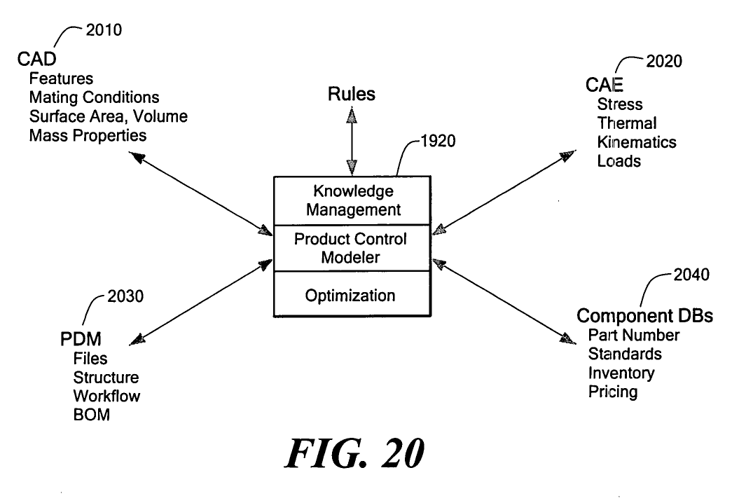

FIG. 20 shows the relationship between the knowledge management application and the integrated systems in greater detail. The knowledge management application 1920 interacts with the CAD system 2010 for modeling such things as features, mating conditions, surface area, volume, and mass properties. The knowledge management application 1920 interacts with the CAE analysis application 2020 for such things as stress, thermal, kinematics, and loads analysis. The knowledge management application 1920 interacts with the PDM application 2030 to generate and utilize such things as files, structure, workflow, and bill of materials (BOM). The knowledge management application 1920 interacts with component databases 2040 for such things as part numbers, standards, inventory, and pricing.

In typical embodiments of the present invention, a model may include multiple geometric components. Each component can be associated with both geometric attributes and non-geometric attributes. Rules can be established for defining relationships between components without necessarily defining that actual parameters of the relationship (such as, for example, a rule that a fan blade assembly must mate with a motor shaft, without necessarily defining the shape or size of the shaft which might affect the type of mating). Components can be organized into classes (such as, for example, three possible motors for a fan assembly can be organized into a “motors” class), and rules can be established for the class as a whole such that the rules are applied to whatever class member is selected for inclusion in a particular model (such as, for example, a generic rule that any of the class of motors must mate with a fan blade component). Rules can be established for selecting a particular member of a class for a particular model (such as, for example, a rule for selecting a particular motor based on the amount of power or the rotational speed required for a model, or a rule for selecting the number of fan blades for the fan blade component based on the volume of air to be moved and other parameters such as the motor selected and the diameter of the fan blade component). Rules relating to “negative” attributes can be defined (such as, for example, a rule that a motor frame must include a hole in a particular location for bolting the motor frame to a chassis) and applied to a model component as a library feature. Rules relating to various non-geometric attributes can be established (such as, for example, rules for deriving manufacturing processes based on the components incorporated into a selected model, or rules for estimating component, sub-assembly, product, and manufacturing costs).

As discussed above, the knowledge management application controls the CAD system through a CAD system API. While the actual CAD functions that can be performed through the API are substantially limited by the API (and are subject to change by the CAD system provider), the specific API functions used and the manner in which the API functions are used are determined by the knowledge management application for performing specific knowledge management operations. In an exemplary embodiment of the present invention, the knowledge management application controls the SOLIDWORKS™ three-dimensional CAD system through its API. In order to control the CAD system, the knowledge management application typically performs such operations as starting SOLIDWORKS™, opening a part file, opening an assembly file, mating a component, deleting a mate, fixing a component, removing a part or assembly, suppressing a component, hiding/showing a component, suppressing a feature, inserting a library feature, removing a library feature, setting a part dimension, setting an assembly dimension, creating a component pattern, removing a component pattern, creating a feature pattern, removing a point in a sketch, removing a feature pattern, setting a custom property, setting component color, and closing SOLIDWORKS™. This is not meant as an exhaustive list, and the knowledge management application can perform other operations as needed. Exemplary API calls and settings for performing the above operations in an exemplary embodiment of the invention are described below.

Starting SOLIDWORKS™ may involve use of the following API functions:
Set SW=New SldWorks.SldWorks
SW.UserControl=False
Set Assembly=SW.OpenDoc6(strFilename, swDocPART, swOpenDocOptions_Silent, “ ”, lngErr, lngMess)

The following SOLIDWORKS™ settings may be used:
swMateAnimationSpeed=0
swLargeAsmModeAutoActivate=swResponseNever
swPerformanceAssemRebuildOnLoad=swResponseAlways
swLoadExternalReferences=swResponseNever
swAutoSaveInterval=0
swBackupCopiesPerDocument=0
swShowErrorsEveryRebuild=False
swMaximizeDocumentOnOpen=True
swSnapToPoints=False
swLargeAsmModeAutoLoadLightweight=False
swLargeAsmModeUpdateMassPropsOnSave=False
swLargeAsmModeAutoRecover=False
swAutoLoadPartsLightweight=False
swPerformanceVerifyOnRebuild=False
swEnablePerformanceEmail=False
swUseFolderSearchRules=False
swExtRefUpdateCompNames=True
swFeatureManagerEnsureVisible=False

Opening a part file typically involves opening the part file, adding the part file as a component to a parent assembly, closing the part file, and rebuilding the top level assembly. The following API functions may be used:
Set objDoc=SW.OpenDoc6(strFilename, swDocPART, swOpenDocOptions_Silent, “ ”, lngErr, lngMess)
Assembly.AddComponent2(strFilename, 0, 0, 0)
SW.CloseDoc objDoc.GetTitle
Assembly.EditRebuild3

Opening an assembly file typically involves opening the part file, adding the part file as a component to a parent assembly, closing the part file, and rebuilding the top level assembly. If assembly dimensions are driven by the knowledge management application, then all components are typically renamed to ensure uniqueness. The following API functions may be used:
Set objDoc=SW.OpenDoc6(strFilename, swDocPART, swOpenDocOptions_Silent, “ ”, lngErr, lngMess)
Set objConfiguration=objDoc.GetActiveConfiguration( )
Set objComponent=objConfiguration.GetRootComponent( )
objComponent.GetChildren
Set objChildDoc=objChild.GetModelDoc
objChildDoc.SaveAs4 strNewFileName swSaveAsCurrentVersion, swSaveAsOptions_Silent, lngErr, lngWarnings
SWAssembly.AddComponent2(strFilename, 0, 0, 0)
SW.CloseDoc objDoc.GetTitle
SWAssembly.EditRebuild3

Mating a component typically involves putting the parent assembly in “edit” mode, selecting the features to mate, adding the mate, and rebuilding the assembly. The mate name is then found and noted by the knowledge management application in the case where a dependent property is changed and the mating is effected. The following API functions may be used:
ObjParentComponent.Select False
Assembly.EditAssembly

Selecting Plane, Axis, or Point
Assembly.SelectByID strFeatureName, strFeatureType, 0, 0, 0 (also used, strFeatureName & “@” strComponentPath, and “Point1@” & strFeatureName)

Selecting Face or Edge (loop through Faces, or Faces and Edges to find name match)
objComponent.GetBody( ), objBody.GetFirstFace( ), objBody.GetNextFace( ), objFace.GetEdges, Assembly.GetEntityName(obj)
Assembly.AddMate IngMateType, IngAlignType, boolFlip, dblDist, dblAngle
Assembly.EditRebuild3

Finding the Mate Created (find the MateGroup, move to the last SubFeature)
Assembly.FeatureByPositionReverse(i)
objFeature.GetTypeName=“MateGroup”
objMateGroup.GetFirstSubFeature
objMate.GetNextSubFeature( )

Deleting a mate typically involves selecting the mate using the parent assembly's model document and deleting the selection. The following API functions may be used:
Assembly.SelectByID strMateName, “MATE”, 0, 0, 0
Assembly.DeleteSelection False
Assembly.EditRebuild3

Fixing a component typically involves setting the component transform, selecting the component, and fixing the component. The following API functions may be used:
objComponent.GetXform
objComponent.SetXform (varXForm)
objComponent.Select False
Assembly.FixComponent
Assembly.EditRebuild3

Removing a part or assembly typically involves selecting the parent assembly, putting the parent assembly in “edit” mode, selecting the component, and deleting the selection. The following API functions may be used:
objParentComp.Select False
Assembly.EditAssembly
objComponent.Select False
Assembly.DeleteSelection False
Assembly.ClearSelection
Assembly.EditAssembly
Assembly.EditRebuild3

Suppressing a component typically involves checking the suppression state of the component and setting the suppression state, if suppressing the document is saved. The following API functions may be used:
objComponent.IsSuppressed
Set oModelDoc=objComponent.GetModelDoc
oModelDoc.Save3 swSaveAsOptions_Silent, lngErr, lngWarnings
objComponent.Select False
Assembly.EditSuppress2 or Assembly.EditUnSuppress2
Assembly.EditRebuild3

Hiding or showing a component typically involves setting the hidden state appropriately. The following API functions may be used:
objComponent.IsHidden(False)
objComponent.Select False
Assembly.ShowComponent2, Assembly.HideComponent2
Assembly.EditRebuild3

Suppressing a feature typically involves traversing the model documents to find the named feature and setting its suppression state accordingly. The following API functions may be used:
objModelDoc.FirstFeature
objFeature.Name( )
objFeature.GetNextFeature( )
objFeature.IsSuppressed
objFeature.SetSuppression 0
objFeature.SetSuppression 2

Inserting a library feature typically involves selecting the component to receive the feature, putting the component in “edit” mode, selecting the references required for insertion, and inserting the library feature. The new feature and its sub-features are typically renamed. The following API functions may be used:
objParentComponent.Select2 False, 0
Assembly.EditPart2 True, True, ngErr
obj.Select2 True, intMark (Traverse features and select for Edges and Faces)
Assembly.AndSelectByMark(strFeatureName & “@” & strComponentPath, strFeatureType, 0, 0, 0, intMark) (Plane, Point, or Axis)
Assembly.InsertLibraryFeature(strFileName)
Assembly.SelectedFeatureProperties 0, 0, 0, 0, 0, 0, 0, 1, 0, strNewName)
objFeature.GetFirstSubFeature, subFeature.Name( ), subFeature.GetNextFeature( )
Assembly.EditAssembly
Assembly.EditRebuild3

Removing a library feature typically involves selecting component owning the feature, putting the component in “edit” mode, selecting the feature, and deleting the feature using the context of the top level assembly. The following API functions may be used:
objComponent.Select2 False, 0
Assembly.EditPart2 True, True, lngErr
Assembly.ClearSelection
Assembly.SelectByID strFeatureName & “@” & objComponentPath, “BODYFEATURE”, 0, 0, 0
Assembly.DeleteSelection False
Assembly.EditAssembly
Assembly.EditRebuild3

Setting a part dimension typically involves setting the read-only status of the dimension to false, setting the system value for the dimension, and resetting the read-only status of the dimension to true (this is because all dimensions controlled by the knowledge management application are preferably maintained as read-only to prevent modification through the CAD system). A dimension is typically references by a string (e.g. D1 @Sketch1). The following API functions may be used:
objDoc.Parameter(strDimension).ReadOnly=False
objDoc.Parameter(strDimension).SystemValue=varValue
objDoc.Parameter(strDimension).ReadOnly=True

Setting an assembly dimension typically involves all of the steps for setting an assembly dimension, except Parameter is additionally checked for existence on the components. The following API functions may be used:
objDoc.Parameter(strDimension & “@” & strComponent).ReadOnly=False
objDoc.Parameter(strDimension & “@” & strComponent).SystemValue=varValue
objDoc.Parameter(strDimension & “@” & strcomponent).ReadOnly=True
- OR -
objDoc.Parameter(strDimension & “@” & strComponent & “.Part”).ReadOnly=False
objDoc.Parameter(strDimension & “@” & strcomponent & “.Part”).SystemValue=varValue
objDoc.Parameter(strDimension & “@” & strcomponent & “.Part”).ReadOnly=True -
OR -
objDoc.Parameter(strDimension & “@” & strComponent & “.Assembly”).ReadOnly=False
objDoc.Parameter(strDimension & “@” & strcomponent & “.Assembly”).SystemValue=varValue
objDoc.Parameter(strDimension & “@” & strComponent & “.Assembly”).ReadOnly=True

Creating a component pattern typically involves selecting the parent assembly, putting the parent assembly in “edit” mode, selecting the component and the feature pattern, and inserting the feature pattern. The Derived Pattern is typically renamed by traversing the parent assembly and finding the Derived Pattern using the seed component. The following API functions may be used:
objComponent.Select False
Assembly.EditAssembly
Assembly.ClearSelection
Assembly.SelectByID strComponentPath, “COMPONENT”, 0, 0, 0
Assembly.AndSelectByID strPatternName & “@ ” & strComponentPath2, “BODYFEATURE”, 0, 0, 0
Assembly.InsertDerivedPattern
Set objFeature=objDoc.FirstFeature
objFeature.GetTypeName=“DerivedSketchPattern”
arrSeed=def.SeedComponentArray( )
arrSeed(i).Name
def.ReleaseSelectionAccess
Set objFeature=objFeature.GetNextFeature

Removing a component pattern typically involves selecting the Derived Pattern from the parent model document and deleting the selection. In some models, the referenced configuration may need to be reset to prevent future selections from failing on this part. The following API functions may be used:
oParentDoc.ClearSelection
oParentDoc.SelectByID strPatternName, “COMPPATTERN”, 0, 0, 0
oParentDoc.DeleteSelection False
oParentComponent.ReferencedConfiguration=“ ”
Assembly.EditRebuild3

The knowledge management application typically requires a part for each feature in the pattern, and maintains a property containing the X and Y coordinates for each feature. In order to create a feature pattern, the is activated and is used to select the Sketch Pattern. A point for each component required is created, it's identifier is stored, the Sketch is inserted, and the document rebuilt. The Sketch and Feature are selected and a Pattern is created. The Sketch Pattern is then found and renamed by traversing the Document and finding the Pattern using the seed feature. The following API functions may be used:
SW.ActivateDoc2 objDoc.GetTitle, True, lngErr
objDoc.ClearSelection
objDoc.SelectByID strSketchName, “SKETCH”, 0, 0, 0
objDoc.SetAddToDB True
objDoc.EditSketch
Set oPoint=objDoc.CreatePoint2(lngX, lngY, 0)
arrPointID=oPoint.GetId( )
objDoc.InsertSketch
objDoc.EditRebuild3
objDoc.SelectByID strSketch, “SKETCH”, 0, 0, 0
objDoc.AndSelectByID strFeature, “BODYFEATURE”, 0, 0, 0
objDoc.ActivateSelectedFeature
objDoc.FeatureSketchDrivenPattern 1
Set objFeature=objDoc.FirstFeature
objFeature.GetTypeName=“SketchPattern”
arrSeed=def.PatternFeatureArray( )
Set subFeature=arrSeed(i)
objModelDoc.GetEntityName(subFeature)=strSeedName
def.ReleaseSelectionAccess
Set objFeature=objFeature.GetNextFeature
SW.ActivateDoc2 Assembly.GetTitle, True, IngErr
SW.CloseDoc objDoc.GetTitle

Removing a point in a sketch typically involves opening the document containing the sketch, putting the sketch in “edit” mode, traversing the sketch points to find the point with the corresponding identifier, selecting the point, and deleting the selected point. The following API functions may be used:
SW.ActivateDoc2 objDoc.GetTitle, True, IngErr
objDoc.ClearSelection
objDoc.SelectByID strSketchName, “SKETCH”, 0, 0, 0
objDoc.EditSketch
Set oSketch=objModelDoc.GetActiveSketch2( )
arrPoints=oSketch .GetSketchPoints
arrID=arrPoints(i).GetId
arrPoints(i).Select2 False, 0
objDoc.DeleteSelection False
objDoc.InsertSketch
objDoc.EditRebuild3
SW.ActivateDoc2 Assembly.GetTitle, True, lngErr
SW.CloseDoc objDoc.GetTitle

Removing a feature pattern typically involves selecting the derived pattern from the parent model document and deleting the selected derived pattern. The following API functions may be used:
oParentDoc.ClearSelection
oParentDoc.SelectByID strPatternName, “BODYFEATURE”, 0, 0, 0
oParentDoc.DeleteSelection False
Assembly.EditRebuild3

Setting a custom property typically involves verifying the value and setting the value if necessary. The following API functions may be used:
objDoc.GetCustomInfoValue(“ ”, strName)< >varArgument
objDoc.CustomInfo2(“ ”, strName)=varArgument
Assembly.EditRebuild3

Setting a component color typically involves retrieving the MaterialPropertyValues for the component from the component or the model document, changing the first three elements in the array to reflect the new color, and setting the new MaterialPropertyValues on the component. If the color is being removed, the RemoveMaterialProperty is called. The following API functions may be used:
arr=objComponent.MaterialPropertyValues( )
arr=objComponent.GetModelDoc.MaterialPropertyValues( )
objComponent.MaterialPropertyValues=arr
Assembly.EditRebuild 3
objComponent.RemoveMaterialProperty

Closing SOLIDWORKS™ typically involves closing the top level assembly (which is typically the only one open at this point) and calling the Exit App API function.

The following API functions may be used:

SW.QuitDoc strTitle
SW.ExitApp

Various aspects of an exemplary embodiment of the present invention are described hereinafter with reference to modeling a fan. In accordance with an embodiment of the present invention, a fan includes various sub-parts, including a fan assembly, a housing assembly, a motor assembly, and a mounting assembly. Certain components of the fan might have fixed characteristics. For example, a company might purchase three different motors that can be used in a fan, and these motors have fixed dimensions that cannot be changed in the model. CAD models of the motors may be created in the CAD system and imported into the knowledge management application for storage by the knowledge storage application. Other components of the fan might have characteristics that can be determined dynamically during modeling. For example, the dimensions of a fan hub might depend on the motor selected for the model. Models of these components might be created in the CAD system and imported into the knowledge management application, or rules for defining these components might be established. For purposes of the following example, the CAD system is presumed to be the SOLIDWORKS™ three-dimensional CAD system.

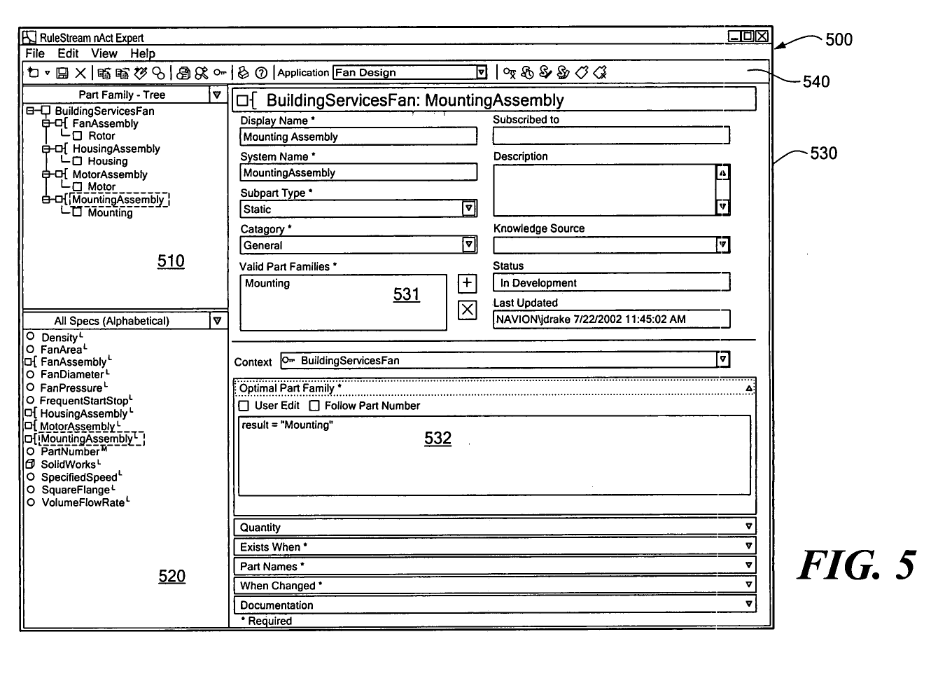

FIG. 5 shows an exemplary user interface screenshot 500 for importing information from the CAD system relating to a mounting assembly, such as might be generated by the knowledge management application in accordance with an embodiment of the present invention. The screenshot 500 displays, among other things, a hierarchical part family tree 510 showing that a BuildingServicesFan part family includes sub-parts entitled FanAssembly, HousingAssembly, MotorAssembly, and MountingAssembly, with the sub-parts having their own part families entitled Rotor, Housing, Motor, and Mounting, respectively. The screenshot 500 shows information relating to the MountingAssembly sub-part (as indicated by the MountingAssembly sub-part being highlighted in the part family tree 510), including a list of all specifications 520 relating to the MountingAssembly sub-part and a window 530 for entering information about the MountingAssembly sub-part. The screenshot 500 also includes a toolbar 540 from which various functions of the knowledge management application (such as creating a new part family, sub-part, property, connection, or CAD specification) can be accessed using either pull-down menus or icons. The window 530 includes a portion 531 showing that there is a single valid part family entitled Mounting associated with the MountingAssembly sub-part. It should be noted that there could be multiple part families associated with the MountingAssembly sub-part, and all valid part families would be displayed in the portion 531. The window 530 also includes a portion 532 for defining a rule to determine the optimal part family for a particular model (in this case, the optimal part family is the Mounting part family by default).

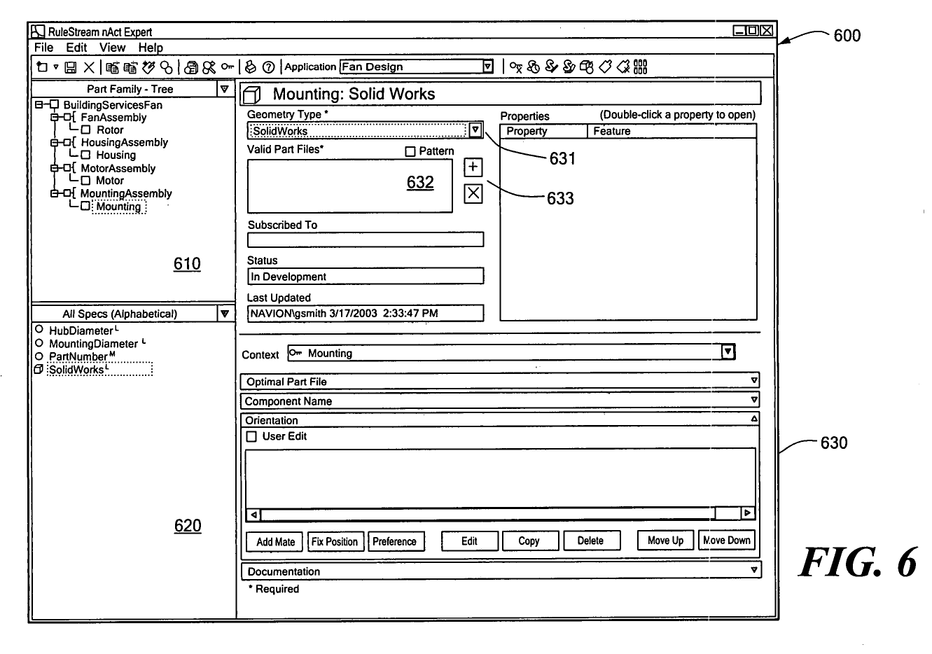

In order to associate a mounting component defined in the CAD system with the Mounting part family, the user might highlight “Mounting” in the part family tree 510 and then select a function from the toolbar 540 to create a new geometric specification (this function can be accessed from either the File menu or an icon on the toolbar). FIG. 6 shows an exemplary user interface screenshot 600 for defining a new geometric specification relating to the Mounting part family, such as might be generated by the knowledge management application in accordance with an embodiment of the present invention. The screenshot 600 shows information relating to the Mounting part family of the MountingAssembly sub-part (as indicated by the Mounting part family being highlighted in the part family tree 610), including a list of all specifications 620 relating to the Mounting part family and a window 630 for entering the new geometric specification for the Mounting part family. The window 630 shows the geometry type 631 (in this case, “SolidWorks”) and a list of valid CAD part files 632 associated with the Mounting part family (in this case, none have yet been specified).

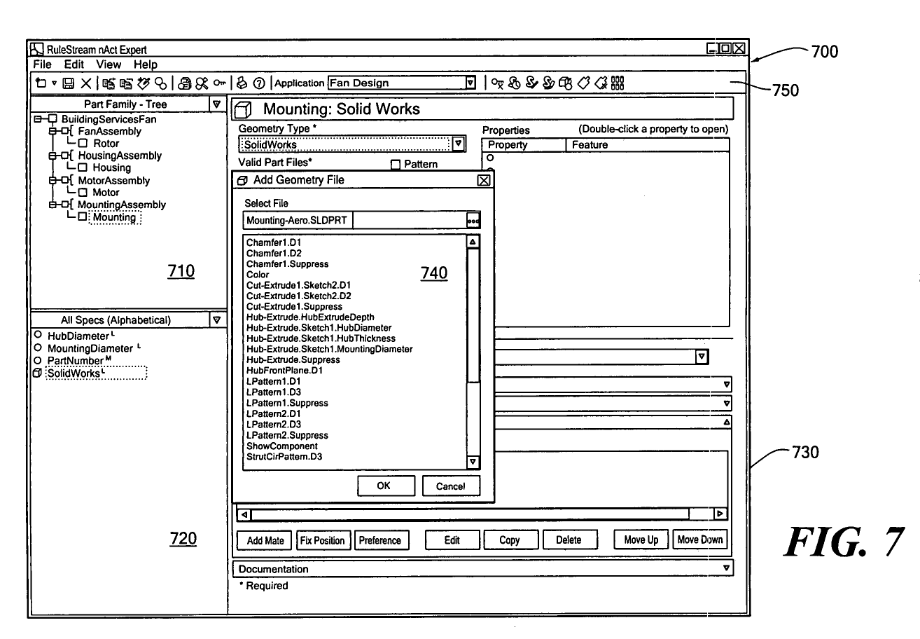

In order to associate a CAD part file with the Mounting part family, the user might select the “add part file” control 633 and enter the name of a CAD part file, in which case the knowledge management application imports from the CAD system information relating to the specified CAD part file. The knowledge management application preferably displays a list of parameters defined for the part in the CAD part file. FIG. 7 shows an exemplary user interface screenshot 700 displaying information upon entry of the name of a new CAD part file, such as might be generated by the knowledge management application in accordance with an embodiment of the present invention. The screenshot 700 shows the part family tree 710, a list of all specifications 720 relating to the Mounting part family, a window 730 showing the new valid part file (Mounting-Aero.SLDPR), and a window 740 displaying a list of parameters defined for the part in the CAD part file.

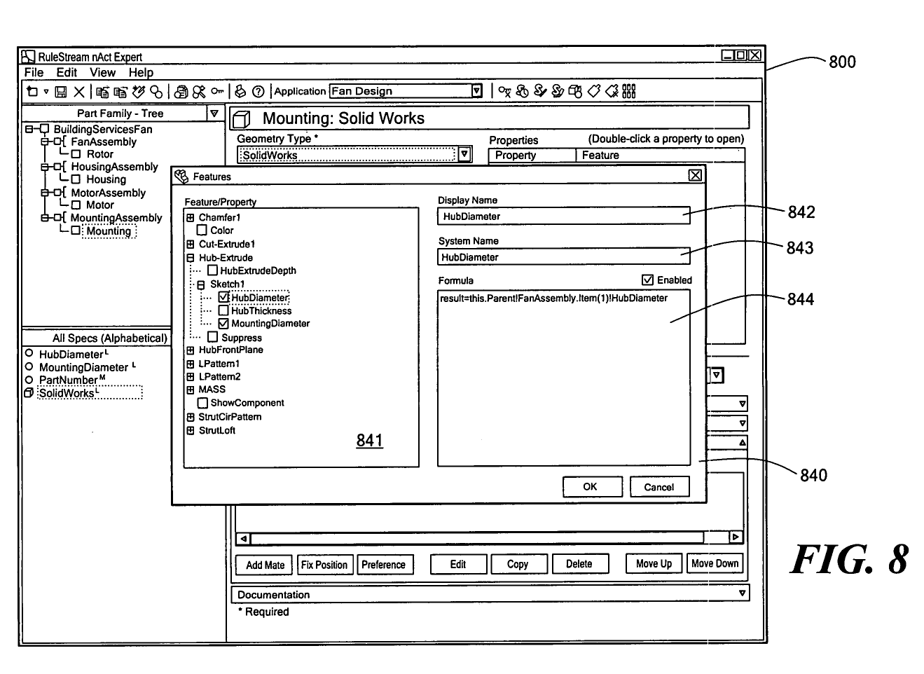

Once the CAD part file has been associated with the Mounting part family, the user typically defines various geometry features and associates the geometry features with specific CAD parts. In order to define a geometry feature and associate the geometry feature with one or more specific CAD parts, the user might select a function from the toolbar 750 to create a new geometry feature (this function can be accessed from either the File menu or an icon on the toolbar). FIG. 8 shows an exemplary user interface screenshot 800 for defining a geometry feature, such as might be generated by the knowledge management application in accordance with an embodiment of the present invention. The screenshot 800 includes a window 840 for defining a geometry feature and associating the geometry feature with one or more specific CAD parts. In this case, a geometry feature having a display name 842 HubDiameter and a system name HubDiameter 843 is associated with a corresponding CAD part entitled HubDiameter by specifying a formula in portion 844.

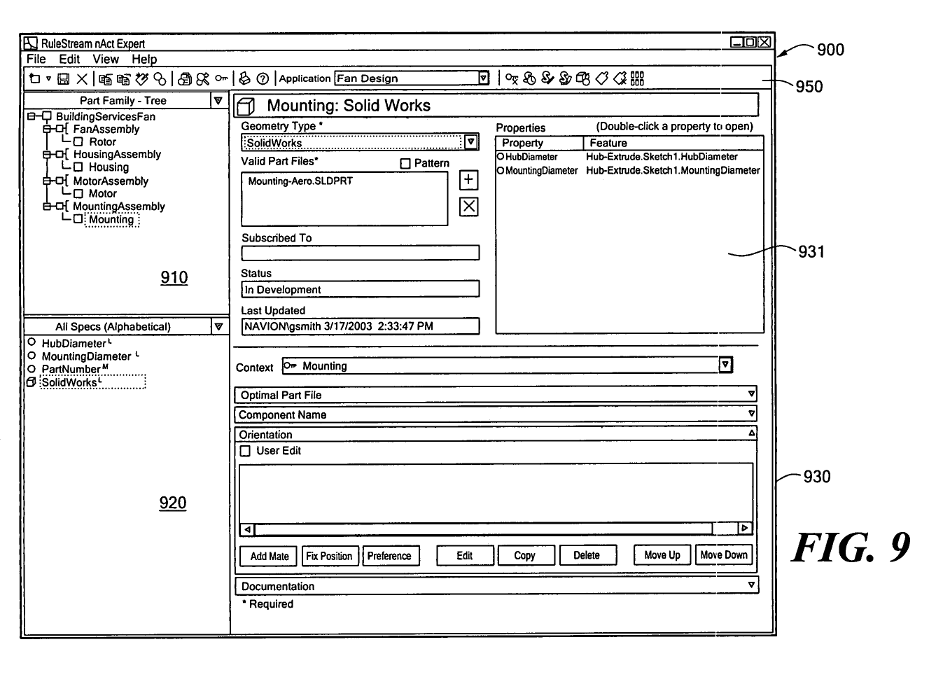

FIG. 9 shows an exemplary user interface screenshot 900 showing geometry features (properties) defined for the CAD part file, such as might be generated by the knowledge management application in accordance with an embodiment of the present invention. The screenshot 900 shows the part family tree 910, a list of all specifications 920 relating to the Mounting part family, and a window 930 including a properties portion 931 showing the geometry features associated with specific CAD parts (in this case, a HubDiameter geometry feature and a MountingDiameter geometry feature).

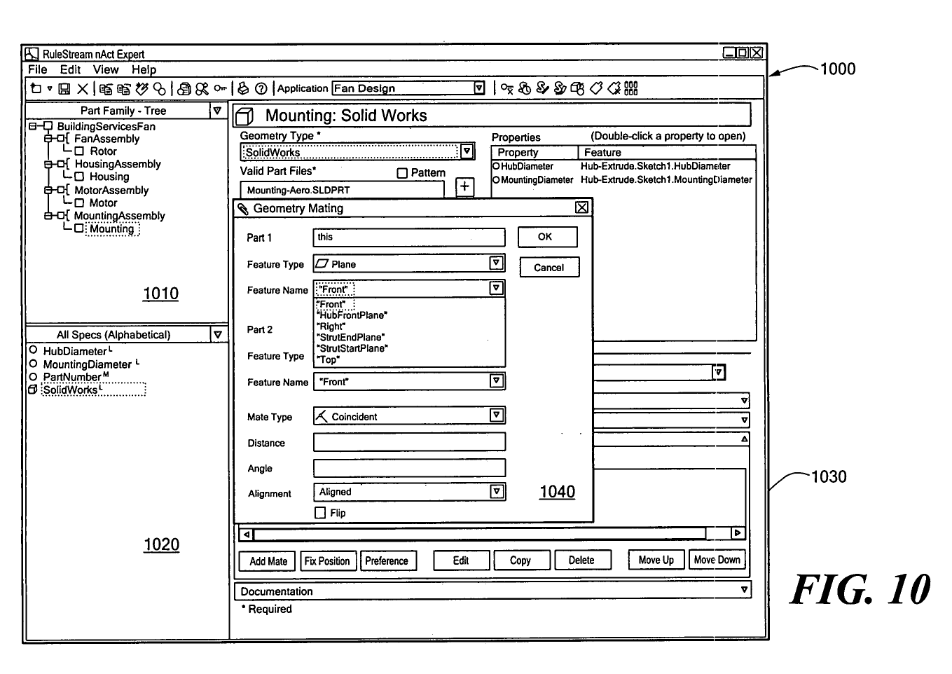

After the geometry features have been defined and associated with corresponding CAD parts, the user typically defines any mating rules associated with the CAD parts file. In order to define a mating, the user may select a function from the toolbar 950 (this function can be accessed from either the File menu or an icon on the toolbar). FIG. 10 shows an exemplary user interface screenshot 1000 for defining a mating, such as might be generated by the knowledge management application in accordance with an embodiment of the present invention. The screenshot 1000 shows the part family tree 1010, a list of all specifications 1020 relating to the Mounting part family, a part file window 1030, and a window 1040 for entering mating information.

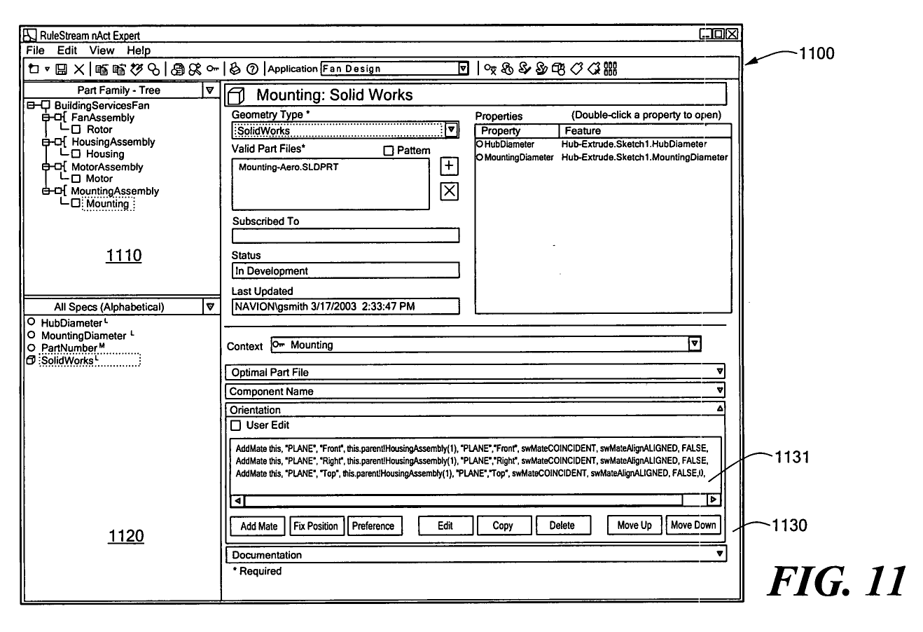

FIG. 11 shows an exemplary user interface screenshot 1100 showing mating definitions, such as might be generated by the knowledge management application in accordance with an embodiment of the present invention. The screenshot 1100 shows the part family tree 1110, a list of all specifications 1120 relating to the Mounting part family, and a window 1130 displaying various mating (orientation) definitions 1131 for the CAD part.

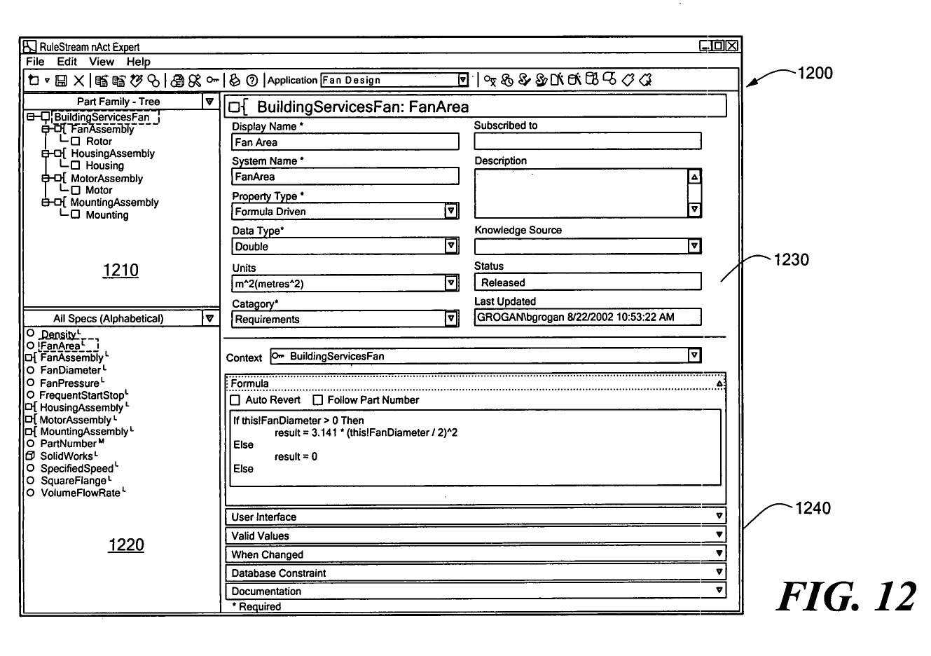

As discussed above, the user can establish rules for attributes that may be difficult or impossible to model in the CAD system, including certain geometric attributes (such as “negative” attributes), certain geometry-based attributes that are not modeled as physical features of a structure or assembly, and non-geometric attributes (such as pricing and processes). For example, continuing with the fan modeling scenario above, it might be useful to establish a rule for computing a non-modeled geometry-based attribute, such as area covered by the sweep of the fan blade component when rotating. While this fan area might be useful, for example, for computing the volume of air moved by a fan blade component having a specified number of blades rotating at a specified rate, the fan area is typically not modeled as a physical feature of the fan. FIG. 12 shows an exemplary user interface screenshot 1200 showing a rule for determining a fan area for the fan, such as might be generated by the knowledge management application in accordance with an embodiment of the present invention. The screenshot 1200 shows the part family tree 1210 (with the part family BuildingServicesFan highlighted), a list of all specifications 1220 relating to the BuildingServicesFan part family (with the FanArea specification highlighted), and a window 1230 displaying the rule 1240 for determining the fan area based on the diameter of the fan blade component. The user can establish other rules that utilize this FanArea value.

After component information has been imported from the CAD system and modeling rules have been established, the knowledge management application controls the CAD system through its API to produce a geometric model according to predetermined specifications. The specifications can be incorporated into the rules and/or provided by a user at run time. The CAD model may be produced for display to the user via the graphical user interface, or may be produced solely for the knowledge management application to obtain model-related information from the CAD system. As an example of the former, the knowledge management application can control the CAD system to generate a model and then produce a graphical display through the graphical user interface including a graphical representation of the model as generated by the CAD system (e.g., by displaying a display window generated by the computer-aided design system), with or without related information from the knowledge management system. As an example of the latter, the knowledge management application can control the CAD system to generate a model and then control the CAD system to compute the surface area of a component for a cost estimate to be produced by the knowledge management application.

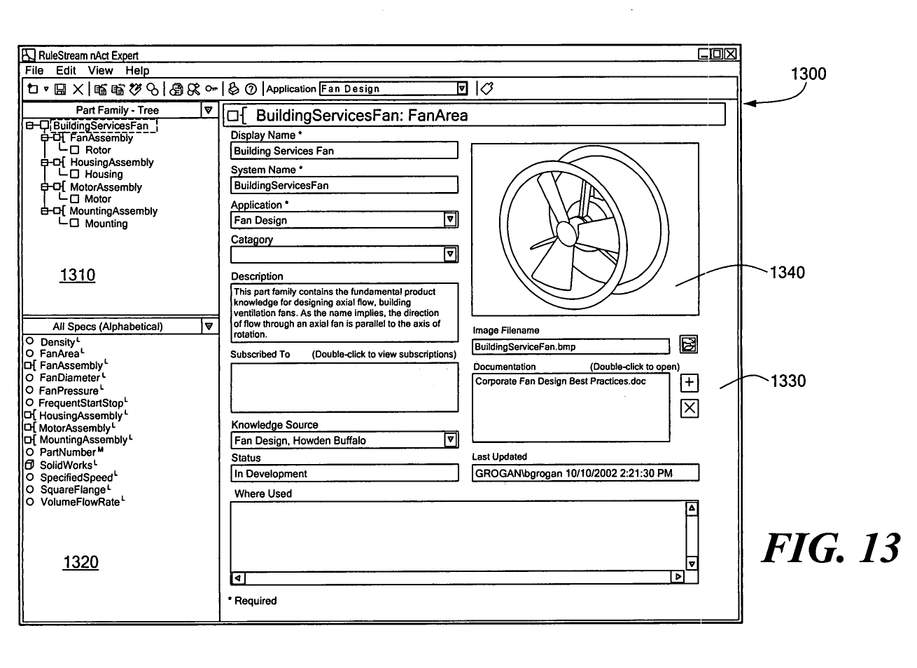

FIG. 13 shows an exemplary user interface screenshot 1300 including an embedded graphical representation of a model generated by the CAD system, such as might be generated by the knowledge management application in accordance with an embodiment of the present invention. The screenshot 1300 shows the part family tree 1310 (with the part family BuildingServicesFan highlighted), a list of all specifications 1320 relating to the BuildingServicesFan part family, and a window 1330 including a portion 1340 including a graphical representation of the model generated by the CAD system.

The user can specify how information is to be displayed by the knowledge management application. For example, the user can specify that the CAD system window be displayed under some conditions but not others, and can also specify what knowledge management system information to display along with the CAD system window.

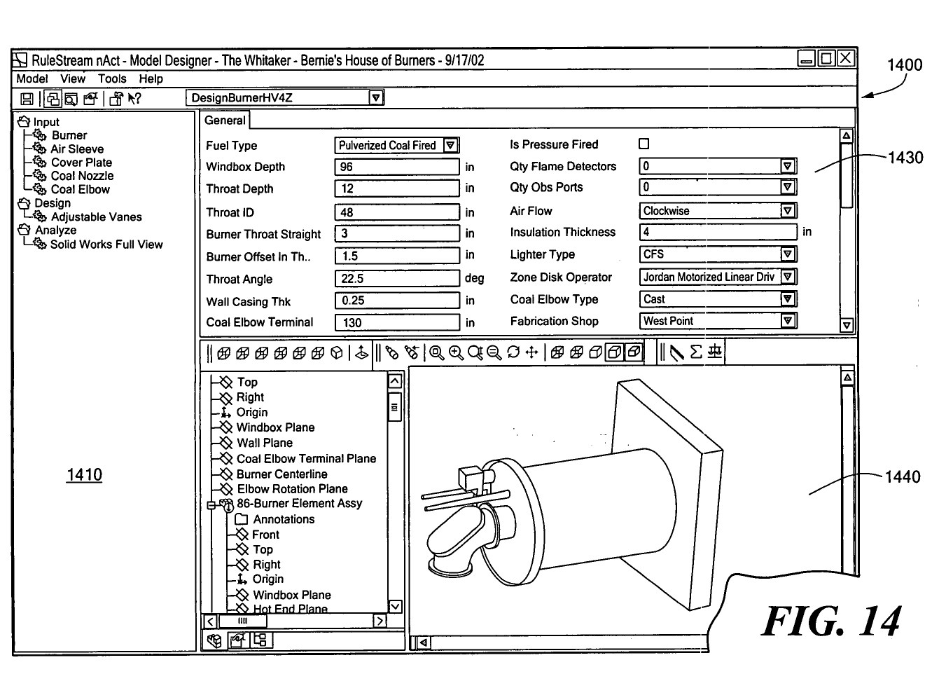

FIG. 14 shows a first exemplary user interface screenshot 1400 including a sub-window generated by the CAD system, such as might be generated by the knowledge management application in accordance with an embodiment of the present invention. The screenshot 1400 displays a function list 1410, information from the knowledge management system 1430, and a sub-window 1440 generated by the CAD system including a graphical representation of the model generated by the CAD system and controls for manipulating the model.

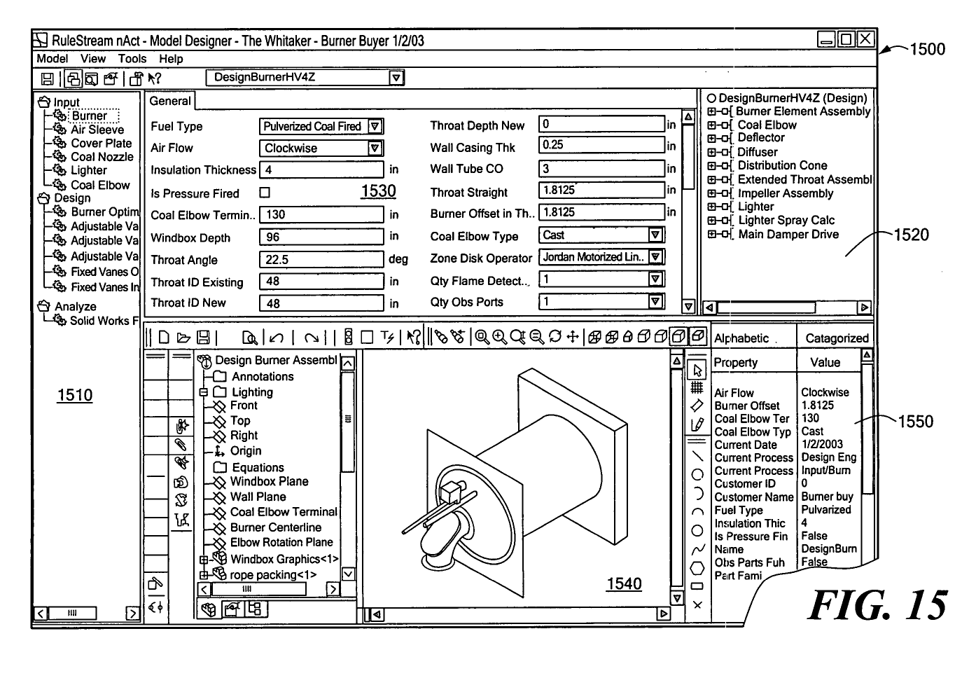

FIG. 15 shows a second exemplary user interface screenshot 1500 including a sub-window generated by the CAD system, such as might be generated by the knowledge management application in accordance with an embodiment of the present invention. The screenshot 1500 displays a function list 1510, a part family tree 1520, information from the knowledge management system 1530, a sub-window 1540 generated by the CAD system including a graphical representation of the model generated by the CAD system and controls for manipulating the model, and properties information 1550.

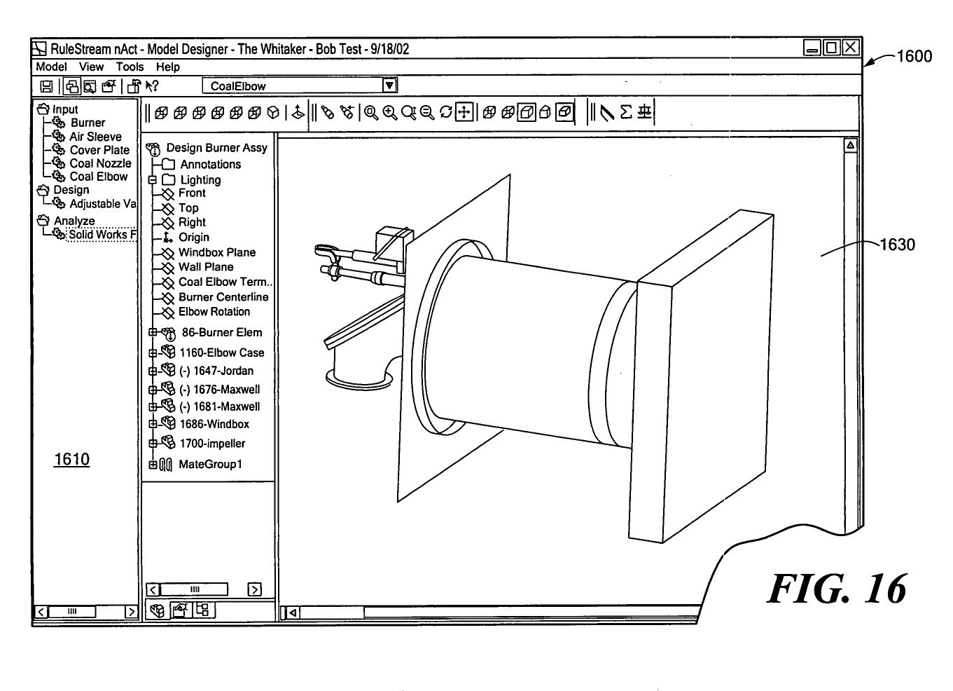

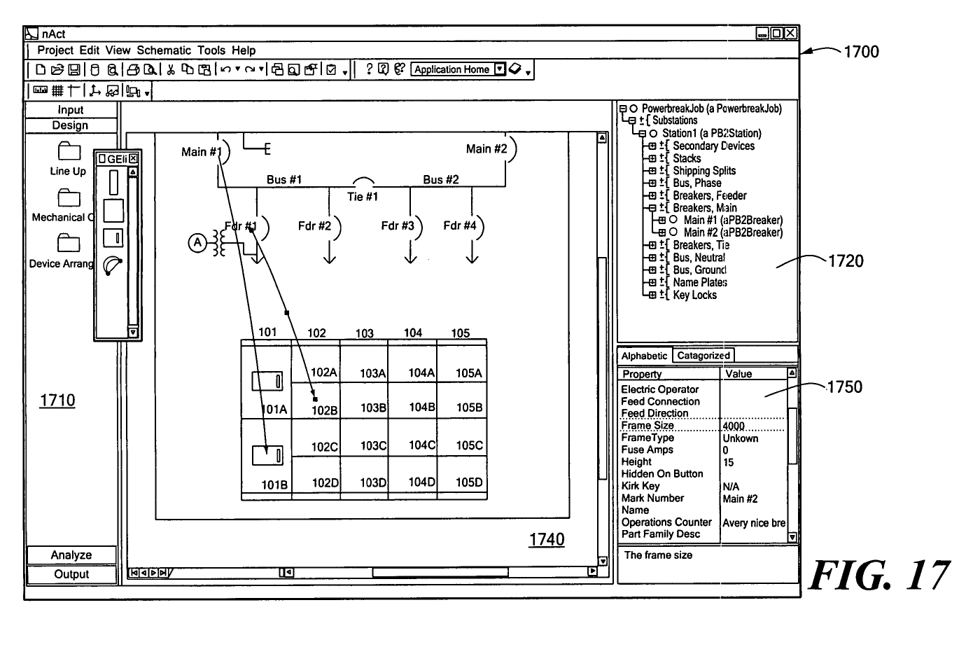

FIG. 16 shows a third exemplary user interface screenshot 1600 including a full view window generated by the CAD system, such as might be generated by the knowledge management application in accordance with an embodiment of the present invention. The screenshot 1600 displays a function list 1610 and a full view window 1630 generated by the CAD system.

In certain embodiments of the invention, the user can make rule changes on the fly, and the knowledge management application will control the CAD system to update the model accordingly and will display the updated graphical representation of the model to the user substantially in real time. In this way, the user essentially gets immediate feedback regarding the rule change.

In certain embodiments of the invention, changes to a model can be made in the CAD system, and the knowledge management application will identify those changes through interactions with the CAD system and will modify and apply rules accordingly. For example, if the user makes a change in the CAD system that overrides a particular rule, the knowledge management application might cause appropriate tracking information to be stored by the knowledge storage application, create one or more revised rules that reflect the change, and apply other rules to update other components of the model according to the rules. The manner in which the knowledge management application can identify CAD system changes depends to a large degree on the CAD system API. For example, the CAD system might communicate the changes to the knowledge management application, or the knowledge management application might monitor or poll the CAD system for changes.

In certain embodiments of the invention, the knowledge management application can cause a particular model part displayed in the CAD system window to be displayed or highlighted when the user is working on rules relating to that part. For example, with reference again to FIG. 13, if the user selects the Motor part family in the part family tree 1310, the knowledge management application might cause the motor to be highlighted in the window 1340, for example, by changing the color of the motor.

In certain embodiments of the invention, the knowledge management application can cause information relating to a particular model part to be displayed when the user highlights that part in the CAD system window. For example, with reference again to FIG. 13, if the user highlights the fan blade component in the CAD window 1340, the knowledge management application might cause information relating to the fan blade component to be displayed in the window 1330, with appropriate highlighting in the part family tree 1310 and the list of specifications 1320.

As discussed above, the knowledge management application can interoperate with two-dimensional CAD systems as well as three-dimensional CAD systems. In an exemplary embodiment of the present invention, the knowledge management application supports both the two-dimensional CAD system VISIO™ and the three-dimensional CAD system SOLIDWORKS™.

FIG. 17 shows an exemplary user interface screenshot 1700 including a window generated by a two-dimensional CAD system, such as might be generated by the knowledge management application in accordance with an embodiment of the present invention. The screenshot 1700 displays a function list 1710, a part family tree 1720, a CAD system window 1740, and properties information 1750.

The knowledge management application can also interoperate with various analysis applications. Typically, the knowledge management application exports information to the analysis application for analysis. The knowledge management application can display analysis information to the user.

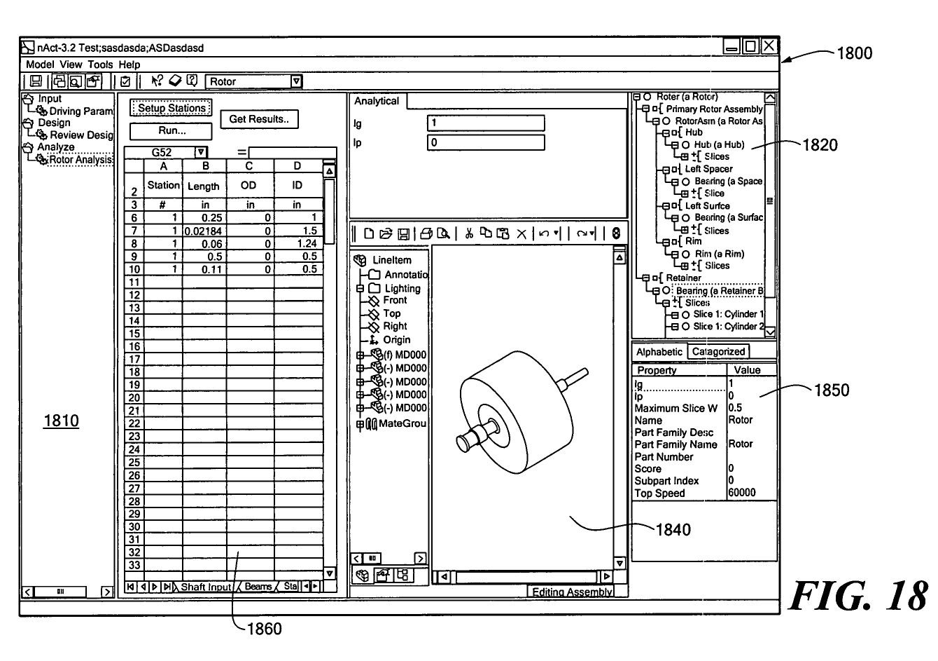

FIG. 18 shows an exemplary user interface screenshot 1800 including an analysis window, such as might be generated by the knowledge management application in accordance with an embodiment of the present invention. The screenshot 1800 displays a function list 1810, a part family tree 1820, a CAD system window 1840, properties information 1850, and an analysis window 1860 generated by the analysis application.

Thus, in certain embodiments of the present invention, structures are defined in a CAD system and are associated with a structure class. Rules are defined for the structure class. When one of the structures is selected by the knowledge management system for a computer-aided design model, the rules are applied to the selected structure. These class-based rules make it easier for the user to define rules, since a single rule defined by the user gets applied to an entire class of structures, and therefore the user does not have to define the rule individually for each structure of the structure class.

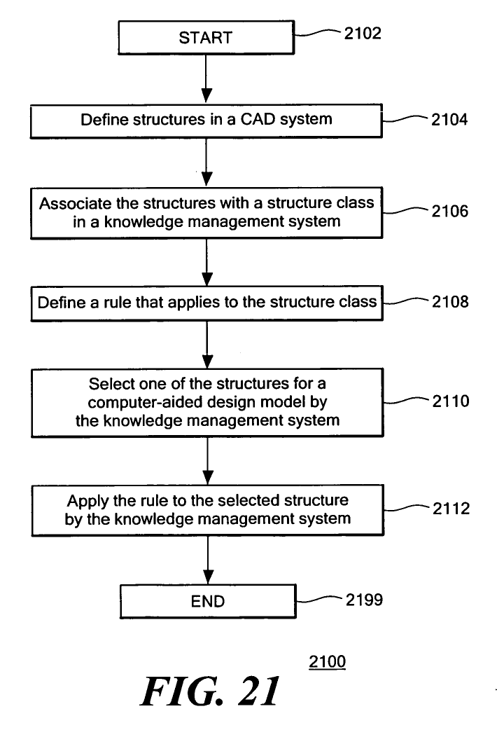

FIG. 21 is a logic flow diagram showing exemplary logic 2100 for class-based rules in accordance with an embodiment of the present invention. Starting in block 2102, structures (such as parts for an assembly) are defined in a CAD system, in block 2104. The structures are associated with a structure class (such as a part family) in a knowledge management system, in block 2106. At least one rule is defined that applies to the structure class, in block 2108. When one of the structures is selected for a computer-aided design model by the knowledge management system, in block 2110, the knowledge management system applies the rule(s) to the selected structure, in block 2112. The logic 2100 ends in block 2199.

As discussed above, the knowledge management application obtains a set of rules from a central database. The set of rules may include rules relating to geometric and non-geometric attributes. The non-geometric attributes may be dependent on geometric attributes. The knowledge management application generates instructions for modeling a geometric structure based on the set of rules. The knowledge management application communicates the instructions to a computer-aided design system, typically through an API of the computer-aided design system. The knowledge management application may produce a graphical display on a graphical user interface including information from the knowledge management system as well as information from the computer-aided design system (such as a graphical representation of a geometric model).

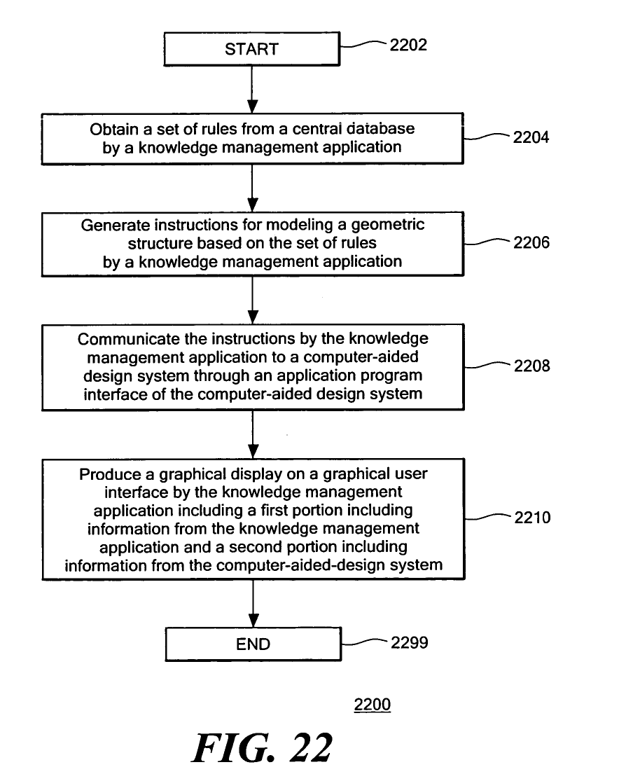

FIG. 22 is a logic flow diagram showing exemplary logic 2200 for the knowledge management application in accordance with an embodiment of the present invention. Starting in block 2202, the logic obtains a set of rules from a central database, in block 2204. The logic generates instructions for modeling a geometric structure based on the set of rules, in block 2206. The logic communicates the instructions to a computer-aided design system, in block 2208, typically through an application program interface of the computer-aided design system. The logic may produce a graphical display on a graphical user interface including a first portion including information from the knowledge management application and a second portion including information from the computer-aided design system, in block 2210. The logic ends in block 2299.

As discussed above, in certain embodiments of the invention, the user can make rule changes on the fly, and the knowledge management application will update the model accordingly and will control the CAD system to display the updated graphical representation of the model to the user substantially in real time. For convenience, such rule changes may be referred to hereinafter as “interactive” rule changes. Interactive rule changes can involve modifying existing rules, adding new rules, adding objects to a model, and adding definition to objects, although deletion of existing objects or definitions is typically not permitted, especially for objects or definitions on which the model depends. These interactive rule changes may be made during a “run time” environment when computer-aided design models are generated from rules, as opposed to a “capture time” when rules are initially captured and stored in a database. Interactive rule changes may be applied to a run-time model without making the changes available generally, or else the interactive rule changes can be applied to the run-time model and also fed back into the captured rules for general availability (i.e., the interactive rule changes can be added to the rules for use in other models).

Thus, rules are captured during a capture time and are stored in a database. The rules define a number of part families for a computer-aided design model. During run time, a computer-aided design model is generated in a working memory based on the set of rules. Interactive rule changes may be made during run time, and the in-memory model is updated based on the interactive rule changes. The set of rules may optionally be updated based on the interactive rule changes so that the interactive rule changes are available generally.

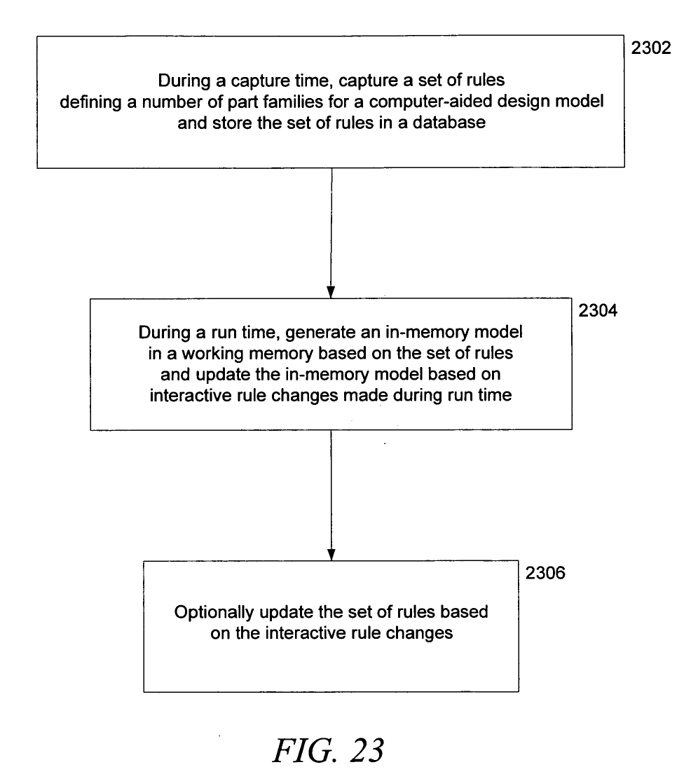

FIG. 23 is a conceptual logic flow diagram describing computer-aided design modeling with interactive rule changes in accordance with an embodiment of the present invention. During a capture time, a set of rules defining a number of part families for a computer-aided design model is captured and stored in a database, in block 2302. Then, during a run time, an in-memory model is generated in a working memory based on the set of rules and the in-memory model is updated based on interactive rule changes made during run time, in block 2304. Instructions may be generated to the CAD system based on the updated in-memory model. Optionally, the set of rules is updated based on the interactive rule changes, in block 2306.

In an exemplary embodiment of the present invention, a set of rules is captured at capture time. The rules define a number of part families. The set of rules is stored in a database. During run time, class files are generated from the set of rules. Each class file contains rules relating to a part family. An in-memory model is generated from the class files during run time, preferably using an interpreter such as Visual Basic (VBA), although the class files can alternatively be compiled. Once a part comes into existence, it gets initialized with all of its characteristics in memory from the class file. Upon receiving an interactive rule change during run time, the in-memory model is updated based on the interactive rule change. The rules in the class files and the database may optionally be updated based on the interactive rule change.

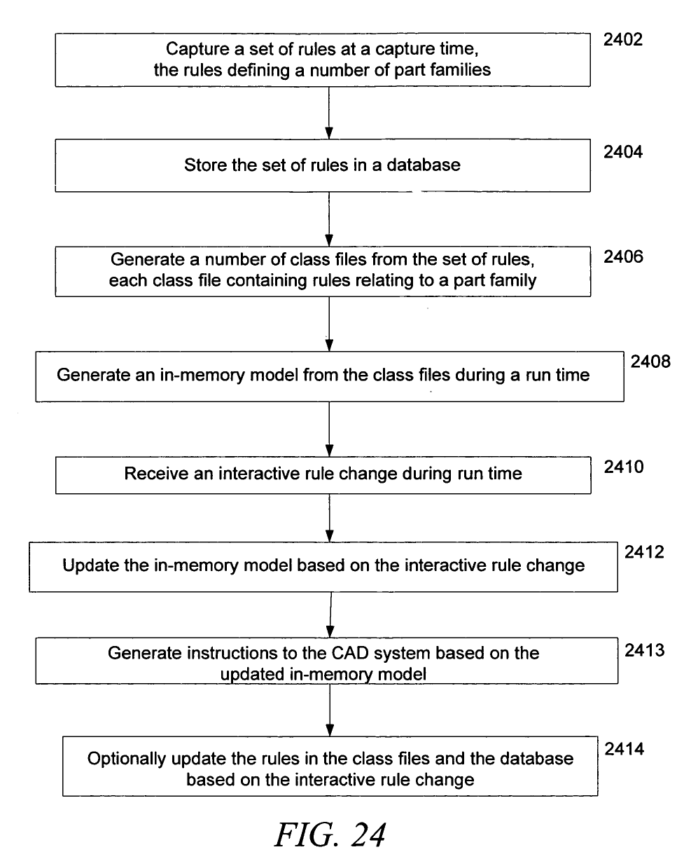

FIG. 24 is a logic flow diagram showing exemplary logic for computer-aided design modeling with interactive rule changes in accordance with an embodiment of the present invention. In block 2402, a set of rules is captured at a capture time. The rules define a number of part families. In block 2404, the set of rules is stored in a database. In block 2406, a number of class files are generated from the set of rules, where each class file contains rules relating to a part family. In block 2408, an in-memory model is generated from the class files during a run time. Upon receiving an interactive rule change during run time, in block 2410, the in-memory model is updated based on the interactive rule change, in block 2412. In block 2413, instructions are generated to the CAD system based on the updated in-memory model. In block 2414, the rules in the class files and the database are optionally updated based on the interactive rule change.

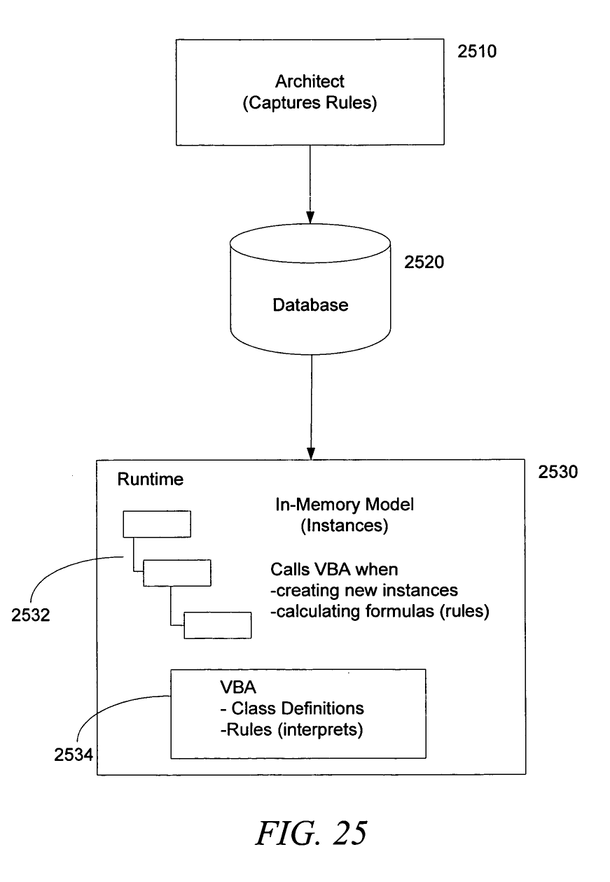

FIG. 25 is a conceptual block diagram showing a computer-aided modeling system with interactive rule changes in accordance with an embodiment of the present invention. Among other things, the system includes an architect facility 2510 for capturing rules during capture time, a database 2520 for storing the rules, and a runtime facility 2530 for generating computer-aided design models during run time. The runtime facility 2530 includes a VBA facility 2534 for handling class definitions and rule interpretation, and also includes an in-memory model facility 2532 for generating the in-memory model. The in-memory model facility 2532 calls the VBA facility 2534 when creating new instances and for calculating formulas (rules).

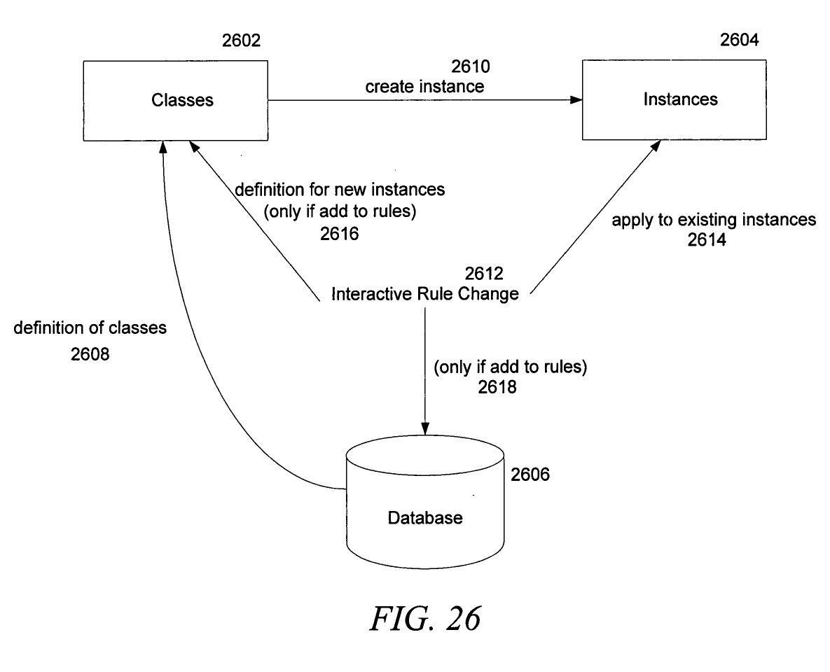

FIG. 26 is a conceptual block diagram showing the relationships between rules, classes, and instances for computer-aided design modeling with interactive rule changes in accordance with an embodiment of the present invention. Classes 2602 are generated from rules obtained from database 2606, as indicated by path 2608. Instances 2604 are generated from classes 2602, as indicated by path 2610. An interactive rule change 2612 is applied to instances 2604, as indicated by path 2614. If the interactive rule change 2612 is to be added to the rules, then the interactive rule change 2612 is applied to the classes 2602, as indicated by path 2616, and is also stored in the database, as indicated by path 2618.

In exemplary embodiments of the present invention, objects such as subparts, parts, and properties (definitions) can be added to a model using interactive rule changes. A subpart is essentially an abstract definition of the existence, type, and quantity of a part. A part is essentially an instance of a subpart. For example, “wheels” might be a subpart of an automobile, where a specific brand, size, or model might be an instance of a wheel. In accordance with an exemplary embodiment of the present invention, certain objects that are added to a model using interactive rule changes may be categorized generally as either a “manual” type or a “formula driven” type. For manual type objects, the user determines the existence of the object in the model, and the user can specify whether the interactive rule change is to be applied only to the run-time model or is to be added to the rules database for general availability. For formula driven type objects, the existence of an object in a model is determined according to some formula, and the interactive rule change is preferably applied to the run-time model and also added to the rules database by default for general availability.

More specifically, an interactively added subpart can include an existing part or a new part. A CAD file can be imported to represent the part in real-time. Definition can be added to the part. For example, a new property can be added for a part. The new property can drive features in the CAD system geometry (e.g., property X drives the dimension of part Y in the CAD system). Mating and orientation rules can be added for an imported geometry. Parts can be removed from a model, although removal of part definitions is generally not permitted.

Various aspects of the interactive rule change functionality are described below with reference to various screenshots that are used for entering interactive rule changes in an exemplary embodiment of the present invention involving modeling of an automobile.

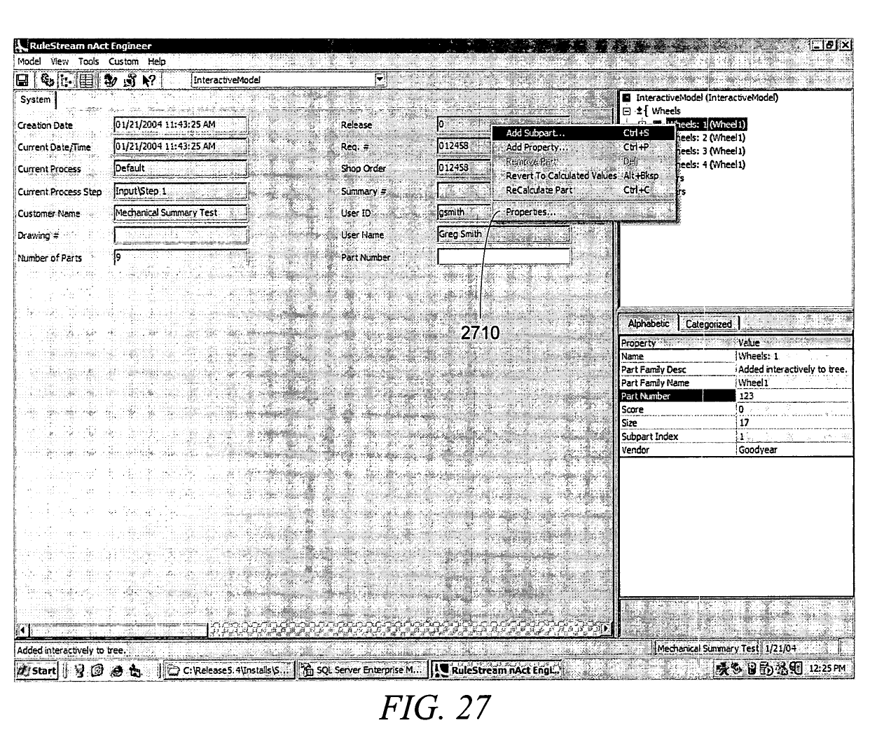

FIG. 27 is an exemplary screenshot showing a menu 2710 for beginning an interactive rule change in accordance with an embodiment of the present invention. The menu 2710 is displayed when the user “right clicks” on an object (in this example, the “Wheels: 1” part). Interactive rule changes can be made at the assembly, subpart, or part level. Among other things, the menu 2710 allows the user to add a subpart, add a property, revert to calculated values, and recalculate a part. In some instances, the menu will allow the user to remove a part, although that option is blocked in this example because the selected object is not permitted to be removed.

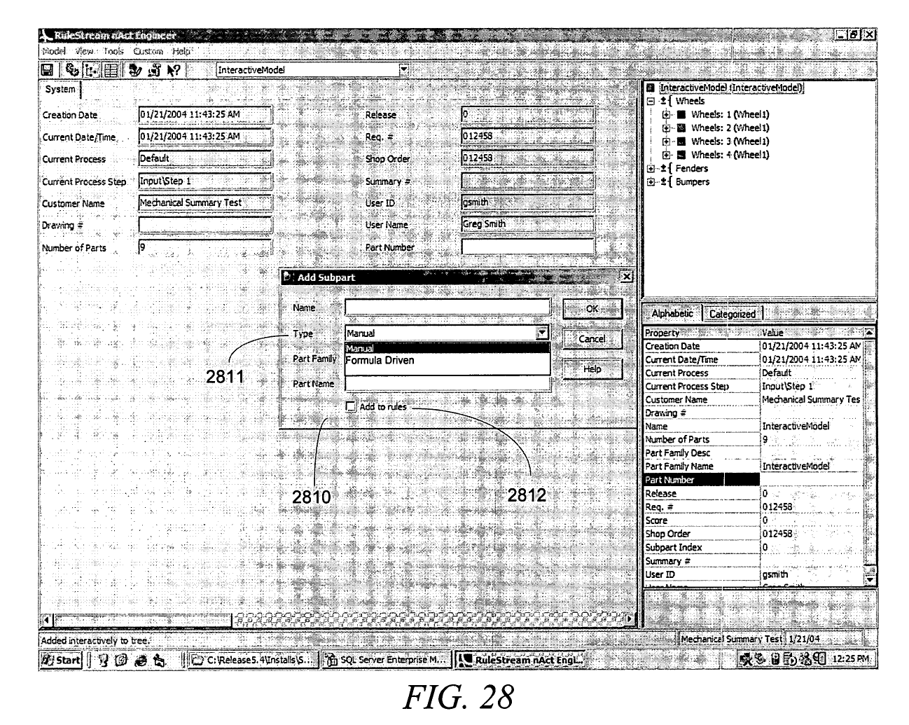

FIG. 28 is an exemplary screenshot showing a dialog box 2810 for interactively adding a subpart in accordance with an embodiment of the present invention. The dialog box 2810 is displayed upon selection of the “Add Subpart” option from a menu. The dialog box 2810 includes a pull-down menu for selecting the subpart type. In this example, the user can select a “Manual” type or a “Formula Driven” type. The dialog box 2810 also includes an “add to rules” checkbox 2812 allowing the user to specify whether or not the interactive rule change should be added to the rules. In a preferred embodiment, the user is only permitted to change the “add to rules” checkbox 2812 when the “Manual” type is selected; when the “Formula Driven” type is selected, the “add to rules” checkbox 2812 is “checked” and cannot be changed by the user.

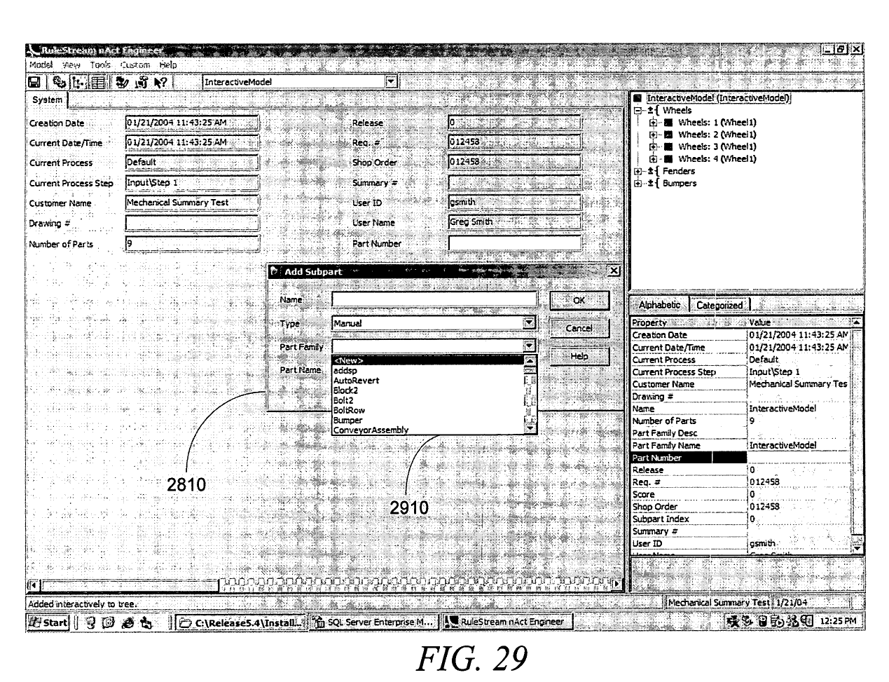

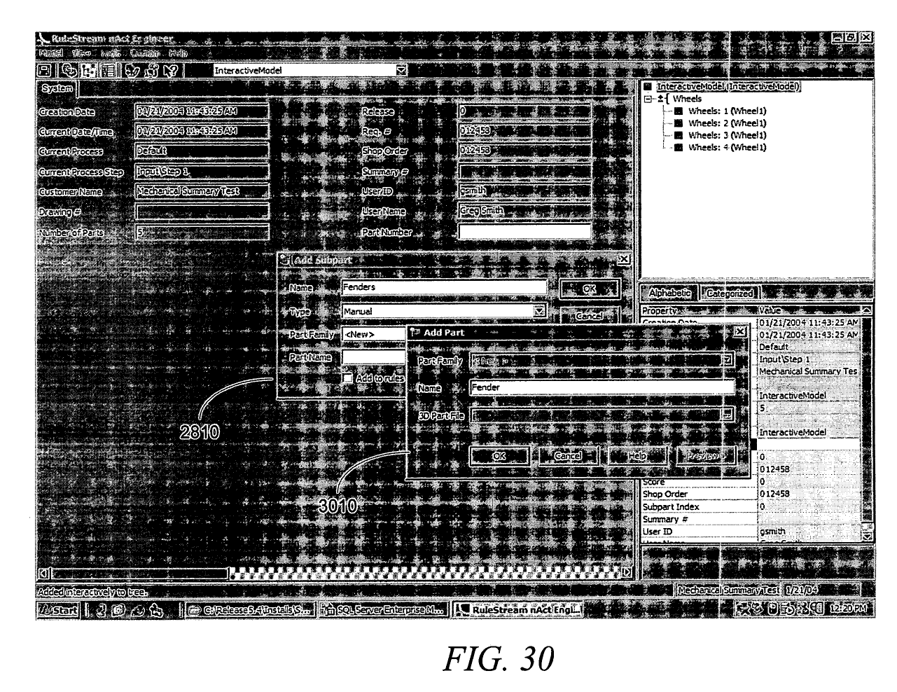

FIG. 29 is an exemplary screenshot showing a pull-down menu 2910 for specifying the part family for the new subpart in accordance with an embodiment of the present invention. The user is permitted to select an existing part family or to specify a new part family.

FIG. 30 is an exemplary screenshot showing a dialog box 3010 for specifying a new part family in accordance with an embodiment of the present invention. The dialog box 3010 is displayed upon selection of “<New>” from the Part Family pull-down menu 2910. The dialog box 3010 allows the user to specify the name of the new part family and also to associate the new part family with a 3D part file from the CAD system. In this example, the dialog box 3010 is being used to add a subpart named “Fender” for the model.

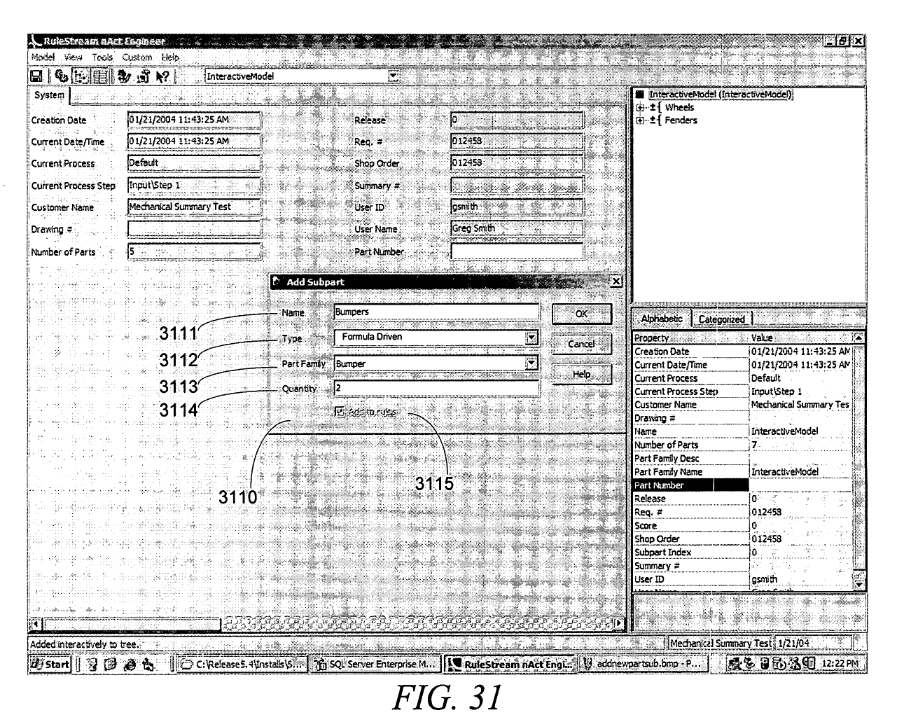

FIG. 31 is an exemplary screenshot showing a dialog box 3110 for adding a new formula-driven subpart in accordance with an embodiment of the present invention. In this example, the dialog box 3110 is being used to add a subpart named “Bumpers” 3111 of type “Formula Driven” 3112 using an existing part family named “Bumper” 3113 and a quantity of two 3114. Because the type is “Formula Driven,” the interactive rule change is added to the rules by default, so the “add to rules” checkbox 3115 is “checked” and cannot be changed by the user.

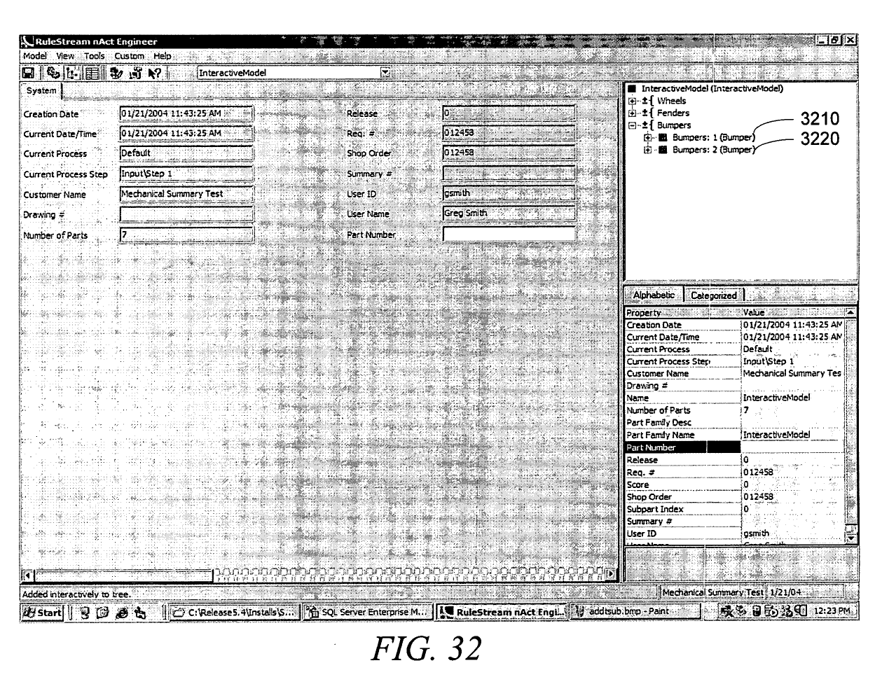

FIG. 32 is an exemplary screenshot showing the results of adding the Bumpers subpart from FIG. 31 in accordance with an embodiment of the present invention. Here, two parts of part family “Bumper” were added to the “Bumpers” subpart, namely 3210 and 3220.

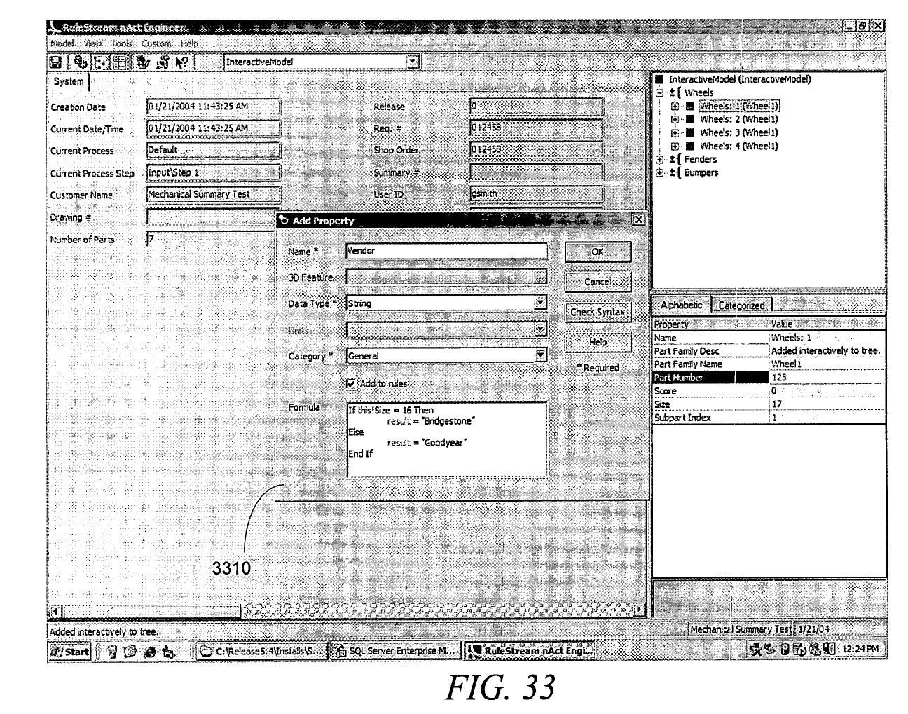

FIG. 33 is an exemplary screenshot showing a dialog box 3310 for adding a new property to an existing part in accordance with an embodiment of the present invention. The dialog box 3310 is displayed upon selection of the “Add Property” option from a menu. In this example, a new property named “Vendor” is being added for the wheels. The property is formula driven (i.e., if wheel size equals sixteen, then vendor is Bridgestone, else vendor is Goodyear), and so is added to the rules by default.

Additional aspects of the interactive rule change functionality are described below with reference to various screenshots that are used for entering interactive rule changes in an exemplary embodiment of the present invention involving modeling of a conveyor assembly.

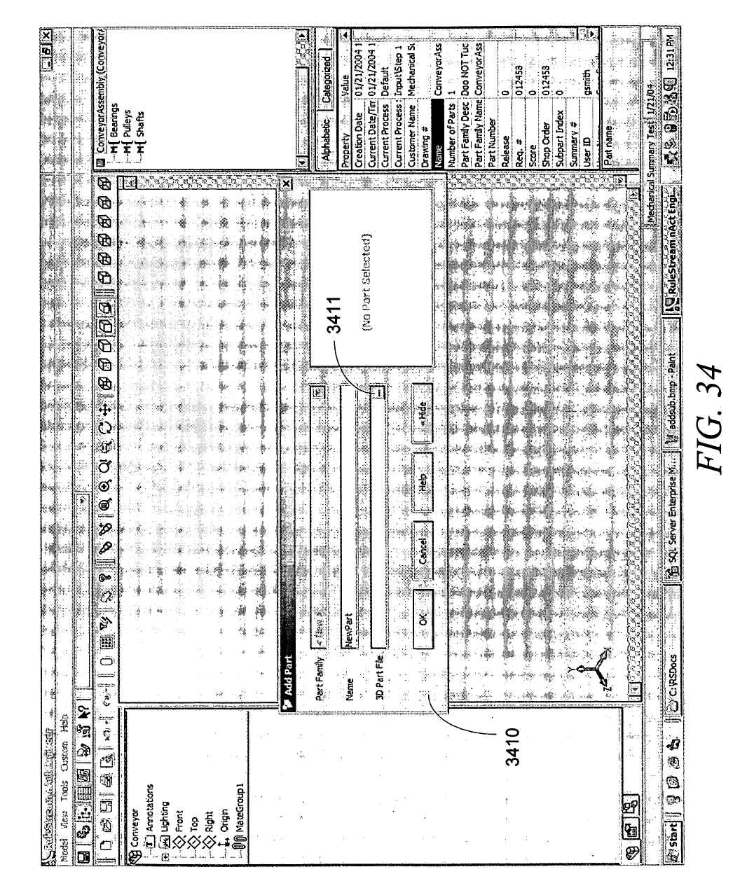

FIG. 34 is an exemplary screenshot showing a dialog box 3410 for adding a new part in accordance with an embodiment of the present invention. The dialog box 3410 includes a pull-down menu 3411 allowing the user to browse existing CAD system part files.

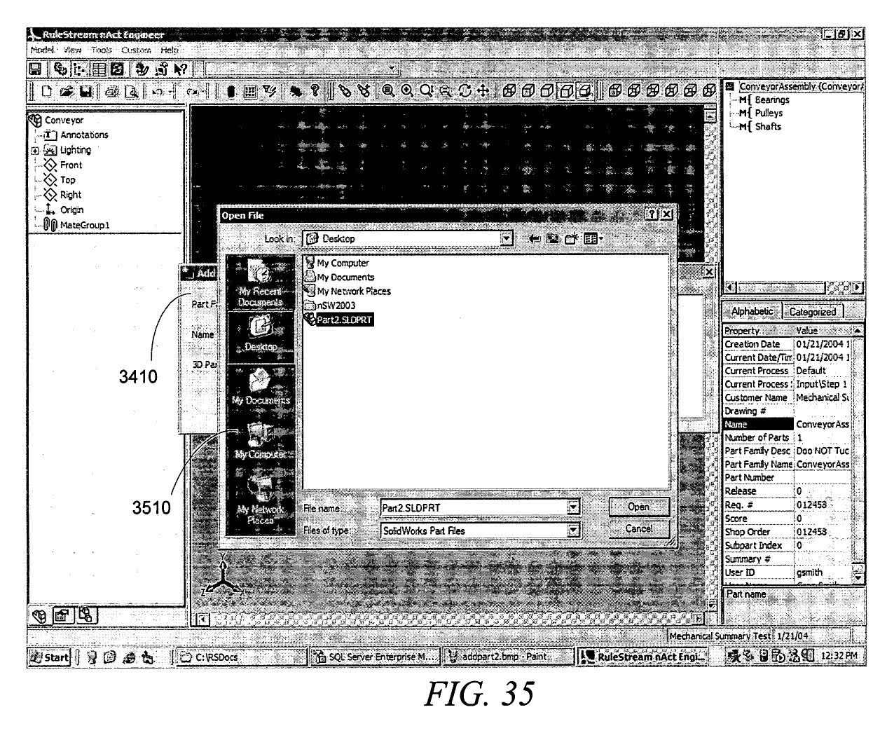

FIG. 35 is an exemplary screenshot showing a dialog box 3510 for selecting an existing CAD system part file in accordance with an embodiment of the present invention. The dialog box 3510 is displayed when the user “clicks” on the pull-down menu 3411 of dialog box 3410. The dialog box 3510 allows the user to browse for CAD system files in different locations (the computer desktop in this example). Here, the dialog box 3510 shows a listing of files including a SolidWorks file named “Part2.SLDPRT” that the user has selected.

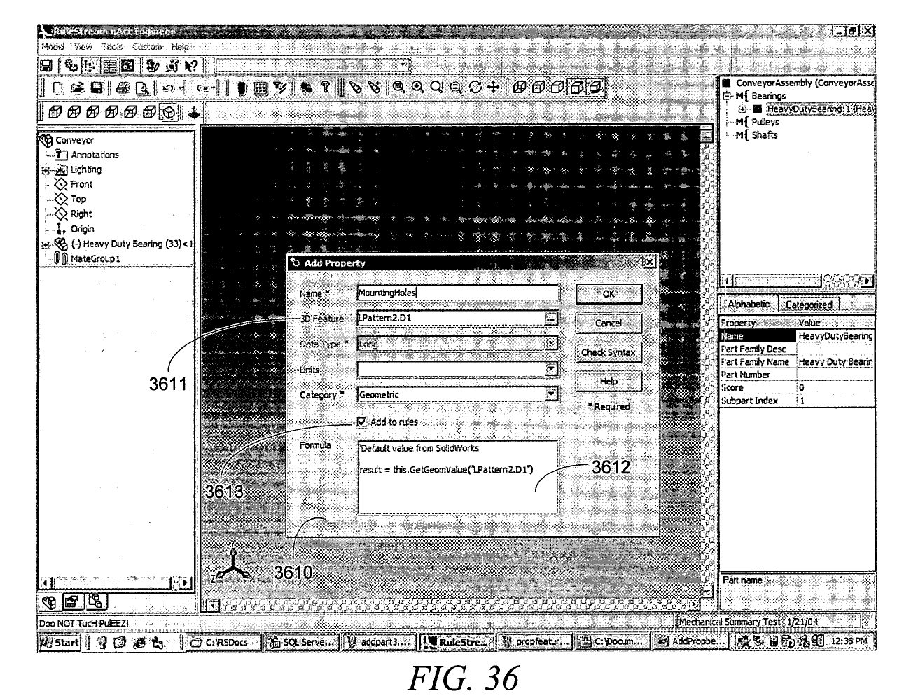

FIG. 36 is an exemplary screenshot showing a dialog box 3610 for adding a new property for a part that is associated with a CAD system file in accordance with an embodiment of the present invention. In this example, a property named “MountingHoles” is being added to drive a feature 3611 in the CAD system called “LPattern2.D1” according to a specified formula 3612. Using checkbox 3613, the user can choose whether or not to add the new property to the rules.

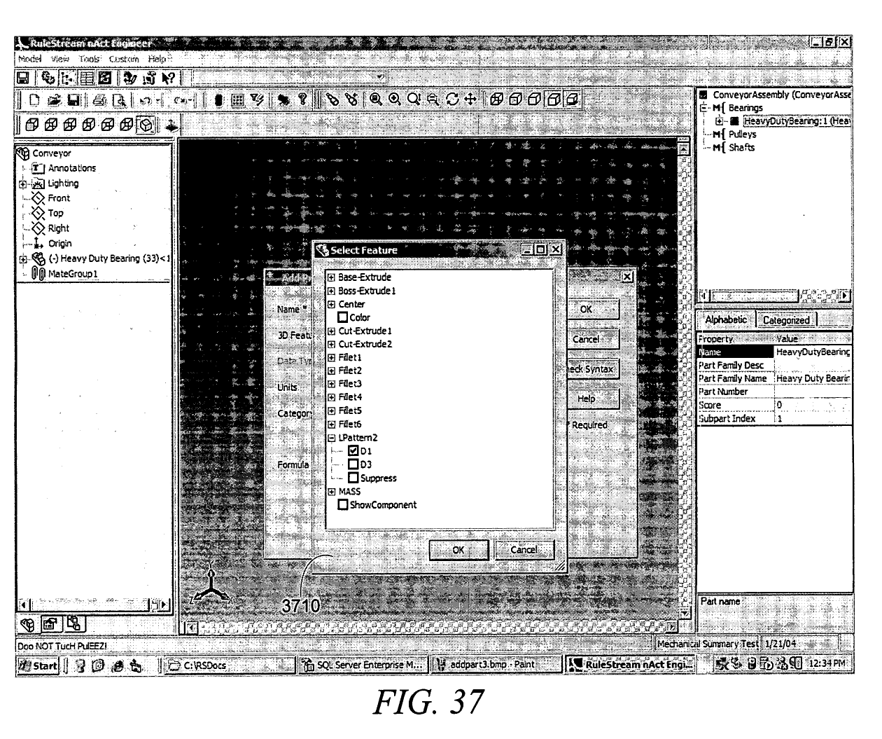

FIG. 37 is an exemplary screenshot showing a dialog box 3710 for selecting the CAD system features to drive with a new property in accordance with an embodiment of the present invention. In this example, the “D1” feature of “LPattern2” is selected.

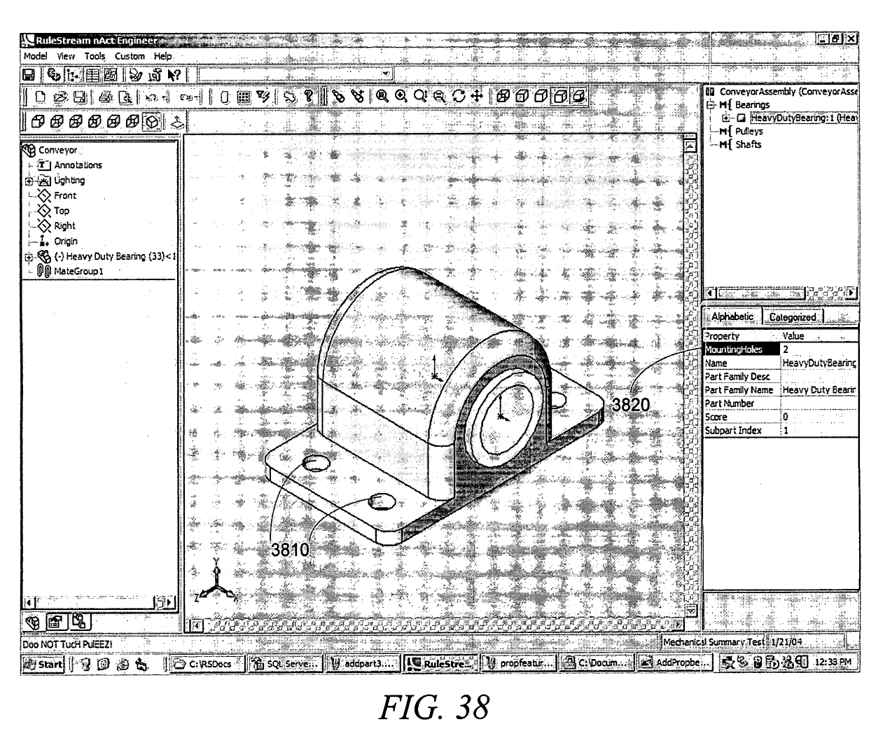

FIG. 38 is an exemplary screenshot showing the results of a newly added property in accordance with an embodiment of the present invention. In this example, two mounting holes 3810 were added to a heavy duty bearing. The property with the corresponding value is displayed in window 3820.

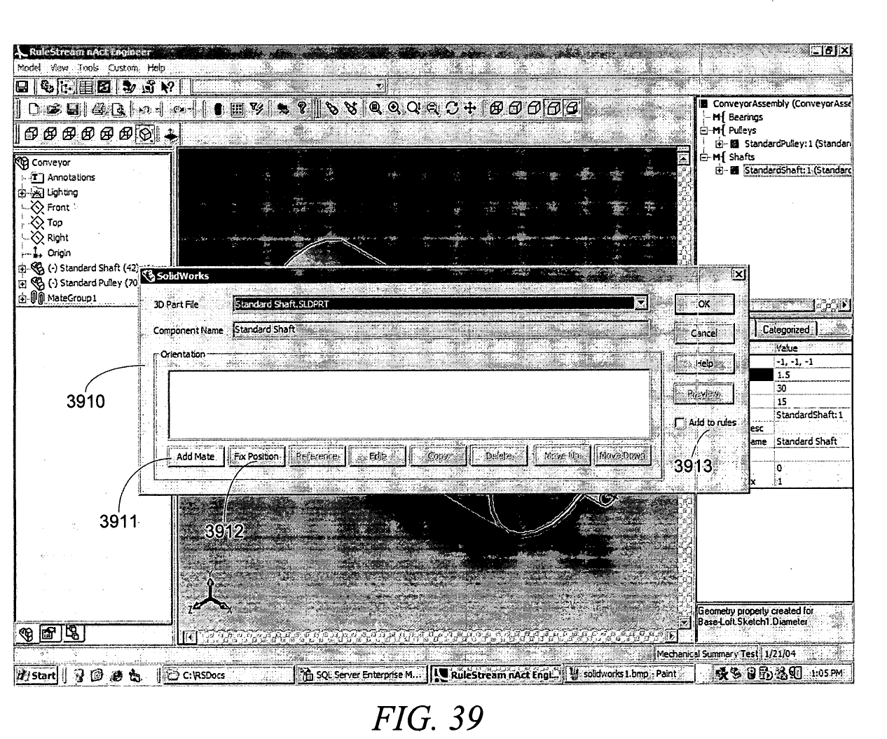

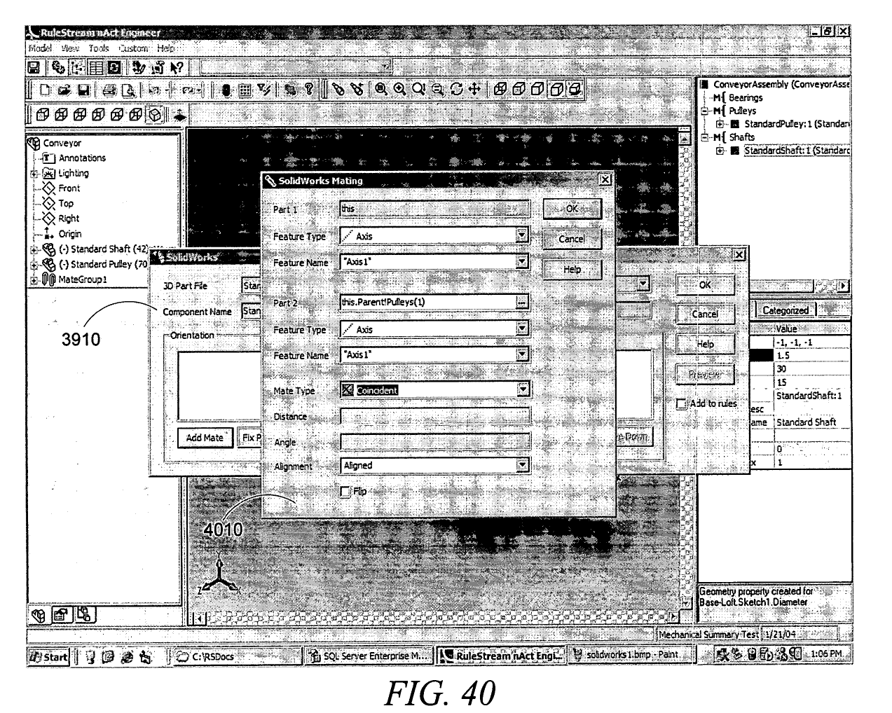

FIG. 39 is an exemplary screenshot showing a dialog box 3910 for adding mating/orientation rules in accordance with an embodiment of the present invention. The dialog box 3910 includes a button 3911 allowing the user to add a new mating (“Add Mate”) and a button 3912 allowing the user to add a new orientation (“Fix Position”). The dialog box 3910 also includes a checkbox 3913 allowing the user to choose whether or not to add the new property to the rules.

FIG. 40 is an exemplary screenshot showing a dialog box 4010 for entering CAD system mating commands in accordance with an embodiment of the present invention. The dialog box 4010 is displayed when the user “clicks” on the button 3911 in dialog box 3910.

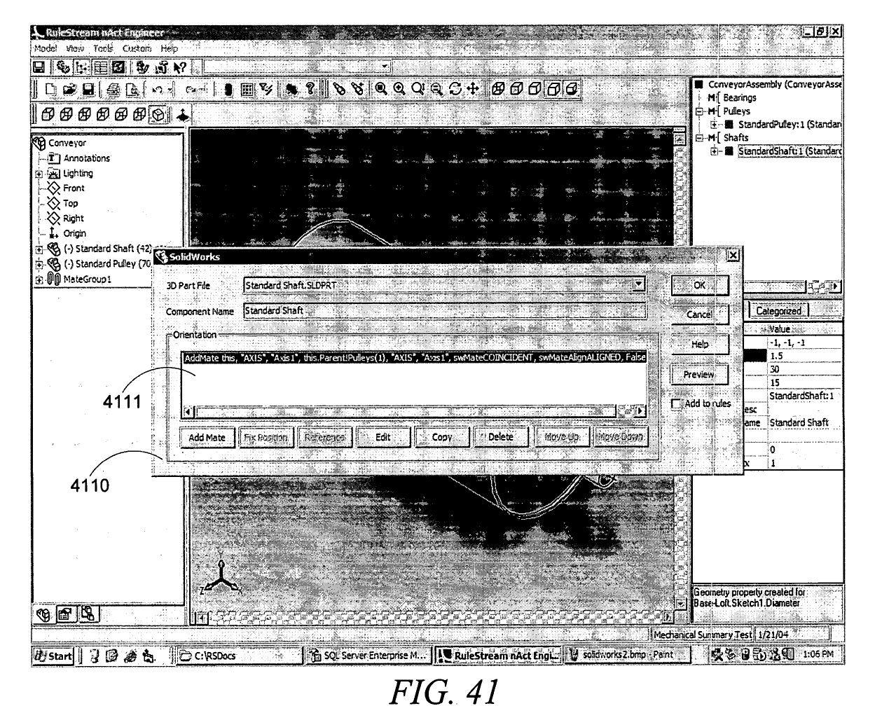

FIG. 41 is an exemplary screenshot showing a dialog box 4110 showing a new mating in accordance with an embodiment of the present invention. The mating command that will be used is shown in window 4111. The user can add a new mating, edit the mating, copy the mating, or delete the mating. The user can also specify whether or not the new mating should be added to the rules.

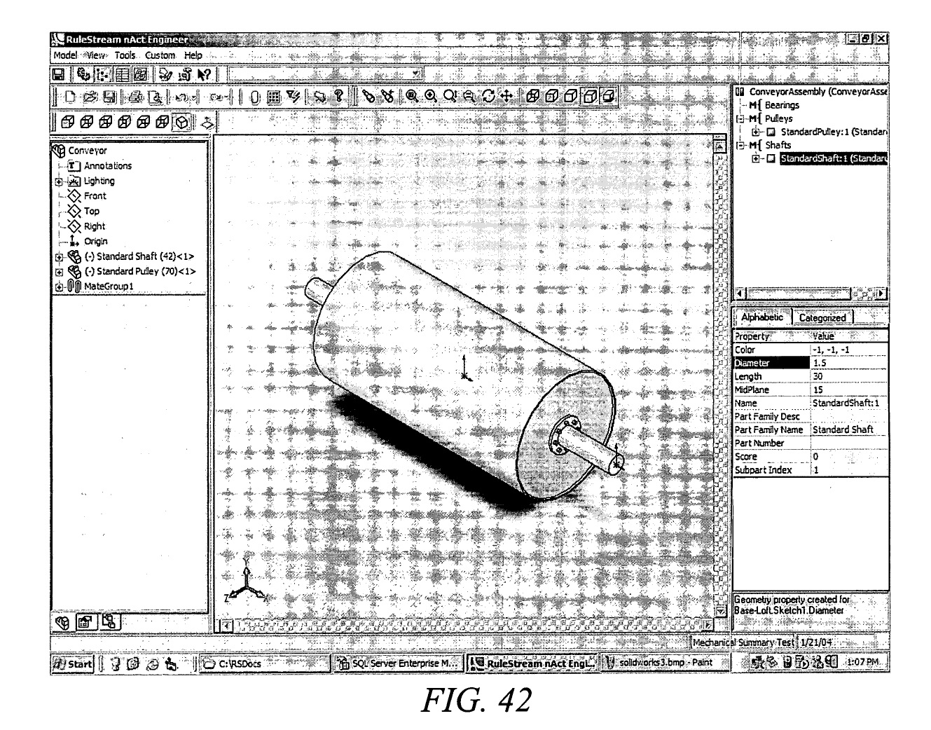

FIG. 42 is an exemplary screenshot showing a computer-aided design model including a new mating in accordance with an embodiment of the present invention. In this example, the new mating mated a pulley with a shaft.

It should be noted that the logic flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In a typical embodiment of the present invention, predominantly all of the knowledge management system applications are implemented as a set of computer program instructions that are executed by a computer under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The present invention may be embodied in other specific forms without departing from the true scope of the invention. The described embodiments are to be considered in all respects only as illustrative and not restrictive.

1. A computer-aided modeling system comprising:
a knowledge management system for managing a set of modeling rules; and
a computer-aided design system controlled by the knowledge management system, wherein the knowledge management system generates instructions for the computer-aided design system based on an in-memory model derived from a set of rules, and wherein the knowledge management system updates the in-memory model and the instructions based on interactive rule changes made by a user.

2. A computer-aided modeling system according to claim 1, wherein the set of rules are captured at a capture time, and wherein the interactive rule changes are made during a run time during which computer-aided design models are generated.

3. A computer-aided modeling system according to claim 1, wherein the knowledge management system comprises:
a capture facility for capturing the set of rules during a capture time; and
a run-time facility for generating the in-memory model and the instructions during a run time, the run-time facility updating the in-memory model and the instructions based on interactive rule changes made by the user during the run time.

4. A computer-aided modeling system according to claim 1, wherein the set of rules are stored in a database, and wherein the knowledge management system selectively updates the set of rules in the database based on the interactive rule changes.

5. A computer-aided modeling system according to claim 1, wherein the knowledge management system produces class files from the set of rules and produces the in-memory model based on the class files, and wherein the knowledge management system selectively updates the class files based on the interactive rule changes and generates an updated in-memory model and updated instructions based on the updated class files.

6. A computer-aided modeling system according to claim 5, wherein the knowledge management system interprets the updated class files to produce the updated in-memory model.

7. A computer-aided modeling system according to claim 5, wherein the knowledge management system compiles the updated class files to produce the updated in-memory model.

8. A computer-aided modeling system according to claim 1, wherein the interactive rule changes include addition of a new subpart for a model.

9. A computer-aided modeling system according to claim 1, wherein the interactive rule changes include addition of a new part for a model.

10. A computer-aided modeling system according to claim 1, wherein the interactive rule changes include addition of a new property for a part for the model.

11. A method for computer-aided design modeling, the method comprising:
generating an in-memory model based on a set of rules;
generating instructions for a computer-aided design system based on the in-memory model;
receiving an interactive rule change;
updating the in-memory model based on the interactive rule change; and
generating updated instructions for the computer-aided design system based on the updated in-memory model.

12. A method for computer-aided design modeling according to claim 11, wherein the set of rules are captured at a capture time, and wherein the interactive rule changes are made during a run time during which computer-aided design models are generated.

13. A method for computer-aided design modeling according to claim 11, wherein the set of rules are stored in a database, and wherein the method further comprises selectively updating the set of rules in the database based on the interactive rule changes.

14. A method for computer-aided design modeling according to claim 11, wherein generating an in-memory model based on a set of rules comprises generating class files from the set of rules and generating the in-memory model based on the class files, and wherein the method further comprises selectively updating the class files based on the interactive rule changes.

15. A method for computer-aided design modeling according to claim 14, wherein generating updated instructions for the computer-aided design system based on the updated in-memory model comprises interpreting the updated class files to produce the updated in-memory model and generating the updated instructions based on the updated in-memory model.

16. A method for computer-aided design modeling according to claim 14, wherein generating updated instructions for the computer-aided design system based on the updated in-memory model comprises compiling the updated class files to produce the updated in-memory model and generating the updated instructions based on the updated in-memory model.

17. A method for computer-aided design modeling according to claim 11, wherein the interactive rule changes include addition of a new subpart for a model.

18. A method for computer-aided design modeling according to claim 11, wherein the interactive rule changes include addition of a new part for a model.

19. A method for computer-aided design modeling according to claim 11, wherein the interactive rule changes include addition of a new property for a part for the model.

20. Apparatus for computer-aided design modeling, the apparatus comprising:
a capture facility for capturing a set of rules and storing the set of rules in a database during a capture time; and
a run-time facility for producing an in-memory model in a working memory based on the set of rules and generating instructions for a computer-aided design system based on the in-memory model during a run time, wherein the run-time facility updates the in-memory model based on interactive rule changes received from a user and generates updated instructions for the computer-aided design system based on the updated in-memory model.

21. Apparatus for computer-aided design modeling according to claim 20, wherein the set of rules are stored in a database, and wherein the run-time facility selectively updates the set of rules in the database based on the interactive rule changes.

22. Apparatus for computer-aided design modeling according to claim 20, wherein the run-time facility produces class files from the set of rules and produces the in-memory model based on the class files, and wherein the run-time facility selectively updates the class files based on the interactive rule changes and generates an updated in-memory model and updated instructions based on the updated class files.

23. Apparatus for computer-aided design modeling according to claim 22, wherein the run-time facility interprets the updated class files to produce the updated in-memory model.

24. Apparatus for computer-aided design modeling according to claim 22, wherein the run-time facility compiles the updated class files to produce the updated in-memory model.

25. Apparatus for computer-aided design modeling according to claim 20, wherein the interactive rule changes include addition of a new subpart for a model.

26. Apparatus for computer-aided design modeling according to claim 20, wherein the interactive rule changes include addition of a new part for a model.

27. Apparatus for computer-aided design modeling according to claim 20, wherein the interactive rule changes include addition of a new property for a part for the model.

28. Apparatus comprising a computer readable medium having embodied therein a computer program for computer-aided design modeling, the computer program comprising:
means for capturing a set of rules for computer-aided design modeling;
means for generating an in-memory model in a working memory based on the set of rules;
means for generating instructions for a computer-aided design system based on the in-memory model;
means for updating the in-memory model based on interactive rule changes received from a user during a run time; and
means for generating updated instructions for the computer-aided design system based on the updated in-memory model.

29. Apparatus according to claim 28, wherein the set of rules are captured at a capture time, and wherein the interactive rule changes are made during a run time during which computer-aided design models are generated.

30. Apparatus according to claim 28, further comprising:
means for storing the set of rules in a database; and
means for selectively updating the set of rules in the database based on the interactive rule changes.

31. Apparatus according to claim 28, wherein the means for generating an in-memory model comprises means for generating class files from the set of rules and means for generating the in-memory model from the class files, and wherein the means for updating the in-memory model based on interactive rule changes comprises means for updating the class files based on the interactive rule changes and means for generating an updated in-memory model based on the updated class files.

32. Apparatus according to claim 31, wherein the means for generating an updated in-memory model based on the updated class files comprises means for interpreting the updated class files to produce the updated in-memory model.

33. Apparatus according to claim 31, wherein the means for generating an updated in-memory model based on the updated class files comprises means for compiling the updated class files to produce the updated in-memory model.

34. Apparatus according to claim 28, wherein the interactive rule changes include addition of a new subpart for a model.

35. Apparatus according to claim 28, wherein the interactive rule changes include addition of a new part for a model.

36. Apparatus according to claim 28, wherein the interactive rule changes include addition of a new property for a part for the model.

37. Apparatus for computer-aided design modeling, the apparatus comprising:
means for generating a computer-aided design model based on a set of rules; and
means for interactively updating the computer-aided design model based on interactive rule changes.
